(19) United States
(12) Patent Application Publication
(10) Pub. No.: US 2025/0370361 A1
(43) Pub. Date: Dec. 4, 2025

(54) IMAGE FORMING METHOD

(71) Applicant: Konica Minolta, Inc., Tokyo (JP)

(72) Inventors: Natsuki ITO, Tokyo (JP); Kenshi MIYAJIMA, Tokyo (JP)

(21) Appl. No.: 19/208,984

(22) Filed: May 15, 2025

(30) Foreign Application Priority Data
May 28, 2024 (JP) 2024-085927

(51) Int. Cl. G03G 9/087; G03G 15/00; G03G 15/20

(52) U.S. Cl. CPC G03G 9/08755; G03G 15/2064; G03G 15/6517; G03G 2215/00455

(57) ABSTRACT

An image forming method includes forming an image on a recording medium with an electrostatic charge image developing toner. The electrostatic charge image developing toner includes a toner base particle containing a release agent. A polar component γ^{p} of a surface energy of the image is equal to or more than 5 mN/m². A dispersion component γ^{d} of the surface energy of the image is equal to or more than 20 mN/m².

### CROSS-REFERENCE TO RELATED APPLICATIONS

The entire disclosure of Japanese Patent Application No. 2024-085927, filed on May 28, 2024, is incorporated herein by reference in its entirety.

### BACKGROUND OF THE INVENTION

### Technical Field

The present invention relates to an image forming method. More specifically, the present invention relates to an image forming method capable of improving applicability of a liquid to a fixed image and adhesiveness of the liquid to the fixed image while using a toner containing a conventional amount of a release agent.

### Description of Related Art

In the production print (PP) market and the industrial printing (IP) market, an electrophotographic image forming method is sometimes used because a required number of prints can be produced on demand and a printing plate is not required.

In an electrophotographic image forming method, by using an electrostatic charge image developing toner, an image that is a toner image heat-fixed is formed on a recording medium. Hereinafter, the “electrostatic charge image developing toner” may be simply referred to as a “toner”, and the “toner image” or “an image that is a toner image heat-fixed” may be referred to as a “fixed image”.

The fixed image is required to have higher quality, and in order to improve the image quality and durability of the fixed image, post-press processing is generally performed. Conventionally, surface modification treatment of a fixed image has been performed by performing surface treatment on the fixed image before post-press processing. Thus, a high-quality fixed image which is easily subjected to post-press processing has been formed.

Examples of the post-press processing include varnishing, laminating, gluing, and decorative-agent, such as foil, supplying. In addition, a technique for forming a high-quality fixed image which is easily subjected to the post-press processing has been disclosed.

For example, in the technique disclosed in Japanese Unexamined Patent Publication No. 2011-59575, a high-quality fixed image is formed by subjecting a fixed image to a discharge treatment (plasma) before post-press processing, and subjecting the fixed image to a surface treatment by setting the water-contact angle of the fixed image to 90° or less. The fixed image has excellent applicability of a liquid substance such as varnish.

However, since the liquid substance such as varnish applied to the fixed image formed by the above-described technique has poor adhesiveness to the fixed image, there is still room for improvement.

### SUMMARY OF THE INVENTION

Incidentally, solids and liquids have finite surface energy, and the finite surface energy affects mechanical work such as deformation and cracking and is consumed as chemical reactions such as oxidation and contamination. The surface energy of the fixed image described above is closely related to the applicability of the liquid substance such as varnish to the fixed image and the adhesiveness to the fixed image after the application of the liquid substance such as varnish. Hereinafter, the “liquid substance such as varnish” may be simply referred to as a “liquid”.

Note that in the present specification, the term “applicability” (or coating properties) refers to the degree of wettability of a liquid with respect to a fixed image. Furthermore, the term “adhesiveness” refers to the degree of adhesion of a liquid after the liquid is applied to a fixed image. Furthermore, the “liquid” includes those having low fluidity and being in a semi-solid state. Examples of those in the semi-solid state include an adhesive. Therefore, the definition of the “liquid” includes not only the “liquid substance such as varnish” but also “those in the semi-solid state such as an adhesive”.

A release agent, which is widely used for improving offset resistance and toner releasability with respect to a fixed image, may be contained in the toner used at the time of fixed image formation. Hereinafter, “toner releasability with respect to a fixed image” may be referred to as “fixing separability”.

In particular, a release agent such as wax has a low affinity with, for example, a liquid substance such as a general varnish having a polar group, due to its nature. If a low surface energy component such as wax is contained in the toner as a release agent, when a liquid is applied to a fixed image, the fixed image easily repels the liquid, and thus the liquid is less likely to be uniformly wet-spread. That is, when the wax exists on the surface of the fixed image, the surface energy of the fixed image decreases, and the applicability of the liquid to the fixed image deteriorates.

Decrease in the surface energy of a fixed image means stabilization of the surface of the fixed image, but a fixed image having a low surface energy is accompanied with various difficulties occurring during post-press processing. For example, when a fixed image formed using a toner containing wax is coated with a liquid as post-press processing, the applicability of the liquid is poor, for example, the liquid is repelled by the fixed image. In addition, even after the application of the liquid to the fixed image, the compatibility between the fixed image having a low surface energy and the liquid is poor, and thus the adhesiveness is poor.

Examples of the method of modifying the surface of the fixed image before post-press processing include a method of performing, on the fixed image, a surface treatment of increasing the surface energy of the fixed image to control the surface energy to be in an appropriate range.

As conventional techniques using the above-described surface treatment method, for example, there are techniques using a corona treatment, a plasma treatment, and the like. However, although the fixed image formed by the above-described technique is excellent in applicability of the liquid, there has been a problem that adhesiveness between the liquid and the fixed image is poor after the liquid wet-spreads. That is, in a case where post-press processing is performed on a fixed image, if the content of the release agent in the toner used in the formation of the fixed image is the conventional amount, there is a problem in that the adhesiveness deteriorates during the post-press processing.

The present invention has been made in view of the above-described problems and circumstances, and an object to be achieved by the present invention is to provide an image forming method capable of improving applicability of a liquid to a fixed image and adhesiveness of the liquid to the fixed image while using a toner containing a conventional amount of a release agent.

In order to solve the above-described problems, the present inventors have investigated the causes and the like of the above-described problems, and as a result, have found that the above-described problems can be solved by controlling the dispersion component and the polar component of the surface energy of a fixed image to be in certain specific ranges while using a toner containing a conventional amount of a release agent, at the time of forming the fixed image, and thus have arrived at the present invention.

That is, the above-described object and so forth of the present invention are achieved by the following means.

To achieve at least one of the abovementioned objects, according to an aspect of the present invention, an image forming method reflecting one aspect of the present invention includes forming an image on a recording medium with an electrostatic charge image developing toner,
wherein the electrostatic charge image developing toner includes a toner base particle containing a release agent,
wherein a polar component γ^{p} of a surface energy of the image is equal to or more than 5 mN/m², and
wherein a dispersion component γ^{d} of the surface energy of the image is equal to or more than 20 mN/m².

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is an example of a schematic diagram illustrating differences between conventional toner base particles and toner base particles according to the present invention;

FIG. 2 is an example of a schematic diagram illustrating differences between a conventional fixed image and a fixed image formed by an image forming method of the present invention;

FIG. 3 is an example of a schematic sectional view of peripheral members around a fixed image forming point in a biaxial belt system of an image forming apparatus;

FIG. 4 is an example of a schematic sectional view of peripheral members around a fixed image forming point in a triaxial belt system of an image forming apparatus; and

FIG. 5 illustrates an example of a configuration of an image forming apparatus provided with a system of winding a recording medium into a roll.

### DETAILED DESCRIPTION

The expression mechanism or action mechanism of the effects of the present invention is not clear, but it is presumed as follows.

An image forming method of the present invention is an image forming method including forming an image on a recording medium using an electrostatic charge image developing toner, wherein the electrostatic charge image developing toner contains toner base particles containing a release agent, a polar component γ^{p} of surface energy of the image is equal to or more than 5 mN/m², and a dispersion component γ^{d} of the surface energy of the image is equal to or more than 20 mN/m².

Conventionally, corona treatment, plasma treatment, or the like is performed on the surface of a fixed image to increase the surface energy of the fixed image, thereby obtaining a high-quality image. However, with these treatments, a fixed image having excellent applicability of a liquid can be formed, but adhesiveness is not excellent.

Therefore, in order to provide a higher-quality fixed image, it is required to improve the adhesiveness while improving the surface energy of the fixed image to enhance the applicability.

In the present disclosure, the surface energy can be expressed as the sum of a dispersion component and a polar component, and the chemical properties of the surface are reflected in the dispersion component γ^{d} and the polar component γ^{p}.

The “dispersion component γ^{d}” is a physical quantity reflecting the density, molecular weight, hardness, and the like of a substance(s), and the “polar component γ^{p}” is a physical quantity directly reflecting the polar group density, activity, and the like on the surface. Note that the dispersion components of solids and liquids do not become “zero”, but the polar components thereof may become “zero”.

In the fixed image formed by the image forming method of the present invention, the polar component γ^{p} of the surface energy of the image is equal to or more than 5 mN/m². When the dispersion component γ^{d} is large, the charge bias of the molecules in the image is large, and the liquid and the fixed image are more strongly attracted to each other in terms of charge, thereby improving the applicability.

Further, in the fixed image formed by the image forming method of the present invention, the dispersion component γ^{d} of the surface energy of the image is equal to or more than 20 mN/m². When the dispersion component γ^{d} is large, the force of attraction between the polar molecules present in the liquid and the polar molecules present on the surface of the fixed image is increased, and the adhesiveness is improved.

In a fixed image formed with an electrostatic charge image developing toner containing a conventional amount of a release agent, it is difficult to achieve both improvement in applicability (applicability) of a liquid to the fixed image and improvement in adhesiveness of the liquid to the fixed image.

However, it is presumed that controlling the dispersion component and the polar component of the surface energy of an image to fall within certain specific ranges while using a toner containing a conventional amount of a release agent in forming a fixed image can attain both improvement in applicability (applicability) of a liquid to the fixed image and improvement in adhesiveness of the liquid to the fixed image, and can form a high-quality fixed image that is more readily subjected to post-press processing.

Hereinafter, embodiments of the present invention will be described with reference to the drawings. However, the scope of the invention is not limited to the disclosed embodiments.

An image forming method of the present invention is an image forming method including forming an image on a recording medium using an electrostatic charge image developing toner, wherein the electrostatic charge image developing toner contains toner base particles containing a release agent, a polar component γ^{p} of surface energy of the image is equal to or more than 5 mN/m², and a dispersion component γ^{d} of the surface energy of the image is equal to or more than 20 mN/m².

This feature is a technical feature common to or corresponding to the following embodiments (aspects).

As an embodiment of the present invention, it is preferable that the polar component γ^{p} of the surface energy of the image is equal to or less than 30 mN/m², and the dispersion component γ^{d} of the surface energy of the image is equal to or less than 30 mN/m², from the viewpoint that the applicability of the liquid to the fixed image and the adhesiveness of the liquid to the fixed image become favorable.

It is preferable that the toner base particles contain crystalline polyester, and the content of the crystalline polyester is in the range of 0.5 to 3.0 mass %, from the viewpoint of improvement in the adhesiveness of the liquid to the fixed image.

It is preferable that the toner base particles contain at least ester-based wax as the release agent, from the viewpoint of improvement in toner releasability.

It is preferable that forming an image on a recording medium using the electrostatic charge image developing toner uses a fixing device of a triaxial belt system from the viewpoint that pressure applied to the recording medium during image formation is dispersed.

It is preferable that after forming an image on a recording medium using the electrostatic charge image developing toner, the recording medium is wound into a roll, from the viewpoint that pressure applied to the recording medium during image formation is dispersed.

Hereinafter, the present invention, constituent elements thereof, and embodiments/aspects for carrying out the present invention will be described in detail. In the present disclosure, numerical values before and after “to” are used to be included in a range as its lower limit value and upper limit value.

Note that the advantages and features provided by one or more embodiments of the present invention will be more fully understood from the following detailed description and the accompanying drawings, which are given by way of illustration only, and not intended to define the limits of the present invention.

### Image Forming Method

An image forming method of the present invention is an image forming method including forming an image on a recording medium using an electrostatic charge image developing toner, wherein the electrostatic charge image developing toner contains toner base particles containing a release agent, a polar component γ^{p} of surface energy of the image is equal to or more than 5 mN/m², and a dispersion component γ^{d} of the surface energy of the image is equal to or more than 20 mN/m².

The toner used in the image forming method of the present invention contains a release agent in order to improve offset resistance, fixing separability, and the like. As described above, in a case where the release agent is a wax which is a low surface energy component, the surface energy of the fixed image becomes low, and the applicability of the liquid to the fixed image becomes poor.

In the conventional technique, although it is possible to increase the applicability of the liquid to the fixed image by increasing the surface energy of the fixed image by performing corona treatment, plasma treatment, or the like on the fixed image, the adhesiveness of the liquid to the fixed image is not excellent.

Therefore, in order to provide a higher-quality image, it is required to improve not only the applicability of the liquid to the fixed image but also the adhesiveness of the liquid to the fixed image.

### 1. Surface Energy of Image

### (1.1) Polar Component and Dispersion Component

The surface energy can be expressed as the sum of a dispersion component and a polar component, and the chemical properties of the surface are reflected in the dispersion component γ^{d} and the polar component γ^{p}. In the present invention, when a fixed image is formed, the dispersion component and the polar component of the surface energy of the image are controlled to be in certain specific ranges while using a toner containing a conventional amount of a release agent. This can achieve both the improvement of the applicability of the liquid to the fixed image and the improvement of the adhesiveness between the liquid and the fixed image.

The “dispersion component γ^{d}” is a physical quantity reflecting the density, molecular weight, hardness, and the like of a substance(s), and the “polar component γ^{p}” is a physical quantity directly reflecting the polar group density, activity, and the like on the surface. Note that the dispersion components of solids and liquids do not become “zero”, but the polar components thereof may become “zero”.

In the fixed image formed by the image forming method of the present invention, the polar component γ^{p} of the surface energy of the image is equal to or more than 5 mN/m². When the dispersion component γ^{d} is large, the charge bias of the molecules in the image is large, and the liquid and the fixed image are more strongly attracted to each other in terms of charge, thereby improving the applicability of the liquid to the fixed image.

Further, in the fixed image formed by the image forming method of the present invention, the dispersion component γ^{d} of the surface energy of the image is equal to or more than 20 mN/m². When the dispersion component γ^{d} is large, the attracting force between the polar molecules present in the liquid and the polar molecules present on the surface of the fixed image increases, and the adhesiveness between the liquid and the fixed image is improved.

Note that since the fixed image formed by the image forming method of the present invention is one before liquid is applied, the above-described “adhesiveness between the liquid and the fixed image” may be rephrased to “adhesiveness of the fixed image to the liquid”.

When the dispersion component γ^{d} of the surface energy of the image is large, the charge bias of the molecules constituting the image is large, and therefore the liquid applied onto the fixed image and the fixed image are more strongly attracted to each other in terms of charge. Therefore, the applicability of the liquid to the fixed image is improved. That is, the liquid wet-spreads over the fixed image.

When the polar component of the surface energy of the image is large, the charge bias of the polar molecules is large, and therefore the polar molecules present on the surface of the fixed image and the polar molecules constituting the liquid are more strongly attracted to each other. Therefore, the adhesiveness of the liquid to the fixed image after the liquid is applied thereto is improved.

Basically, as the dispersion component γ^{d} and the polar component γ^{p} of the surface energy of the image are larger, the adhesiveness of the liquid to the fixed image is more improved.

However, the surface energy present in a solid and a liquid is consumed as mechanical work such as deformation and cracking, and also has an aspect of being consumed as chemical reaction such as oxidation and contamination.

Therefore, when the polar component γ^{p} is equal to or less than 30 mN/m² and the dispersion component γ^{d} is equal to or less than 30 mN/m², the balance of the surface energy is good, and the applicability of the liquid and the adhesiveness of the liquid to the fixed image are good.

### (1.2) Method for Controlling Surface Energy of Image

Examples of the method for controlling the surface energy of an image according to the present invention include the following methods (1) to (4).
(1) Method of changing the type and amount of a component(s) contained in toner base particles contained in a toner used at the time of forming a fixed image
(2) Method of using toner base particles having a core-shell structure contained in a toner used at the time of forming a fixed image, and changing the particle diameter of resin particles constituting the shell
(3) Method of changing the particle diameter of release agent particles contained in toner base particles contained in a toner used at the time of forming a fixed image
(4) Method of dispersing a pressure applied to a fixed image at the time of forming the fixed image to suppress bleed-out of a release agent contained in toner base particles contained in a toner

Examples of the method (1) include a method in which a crystalline polyester is used as a resin contained in toner base particles and the content of the crystalline polyester is made lower than usual, and a method in which an ester-based wax is contained as a release agent.

Examples of the method (2) include a method of, in the case where resin particles constituting the shell are of an amorphous polyester, increasing the particle diameter of the particles of the amorphous polyester. Thus, the release agent contained in the toner base particles is less likely to be exposed on the surface of the fixed image. Thus, the polar component γ^{p} of the surface energy of the image becomes large.

That is, when the particle diameter of the resin particles constituting the shell is increased, the polar component γ^{p} of the surface energy of the image can be increased, and when the particle diameter of the resin particles is decreased, the polar component γ^{p} of the surface energy of the image can be decreased.

Examples of the method (3) includes a method of, in the case where the release agent contained in the toner base particles is a wax, reducing the particle diameter of the particles of the wax. According to this method, the dispersion component γ^{d} of the surface energy of the image becomes large. That is, when the particle diameter of the particles of the release agent contained in the toner base particles is decreased, the dispersion component γ^{d} of the surface energy of the image can be increased, and when the particle diameter of the particles of the release agent contained in the toner base particles is increased, the dispersion component γ^{d} of the surface energy of the image can be decreased.

Examples of the method (4) includes a method of increasing the number of axes in the image forming apparatus used at the time of forming a fixed image more than usual. Specifically, the image forming apparatus usually forms a fixed image by a biaxial belt system, but forms a fixed image by a triaxial belt system by which more dispersion of pressure at the time of image formation can be expected. Alternatively, a method of winding the recording medium on which the fixed image(s) is formed into a roll shape in which more dispersion of pressure can be expected is adopted, and image formation is performed while the recording medium is wound.

### (1.3) Measurement of Surface Energy of Image

The polar component γ^{p} and the dispersion component γ^{d} of the surface energy of the fixed image can be measured and calculated, for example, as follows.

The fixed image is coated with each of water, di-iodine methane, and N-hexadecane as liquid. The contact angle of the fixed image with respect to each liquid is measured using a fully automatic contact angle meter “DMo-701” manufactured by Kyowa Interface Science Co., Ltd, and each component of the surface energy is calculated using the theoretical formula of Kitazaki and Hata on the basis of the measurement result with respect to each liquid.

### 2. Structure of Toner Base Particles

The electrostatic charge image developing toner according to the present invention includes toner base particles having a core-shell structure. The “core-shell structure” refers to a form in which a resin forming a shell layer is aggregated and fused on the surface of core particles. The shell layer may not cover the entire surface of the core particles, and the core particles may be partially exposed.

It is preferable that the toner base particles according to the present invention have a core-shell structure, and in the core-shell structure, the core particles contain a crystalline resin and an amorphous resin, and the shell layer contains an amorphous polyester.

It is also preferable that the toner base particles according to the present invention have a core-shell structure, and in the core-shell structure, the shell layer is a hybrid amorphous polyester. The hybrid amorphous polyester is a resin in which a vinyl-based polymerization segment and a polyester-based polymerization segment are bonded.

The term “vinyl-based polymerization segment” refers to a portion derived from a vinyl resin. That is, it means a molecular chain having the same chemical structure as the molecular chain constituting the vinyl resin.

The term “polyester-based polymerization segment” refers to a portion derived from a polyester. That is, it means a molecular chain having the same chemical structure as the molecular chain constituting the polyester.

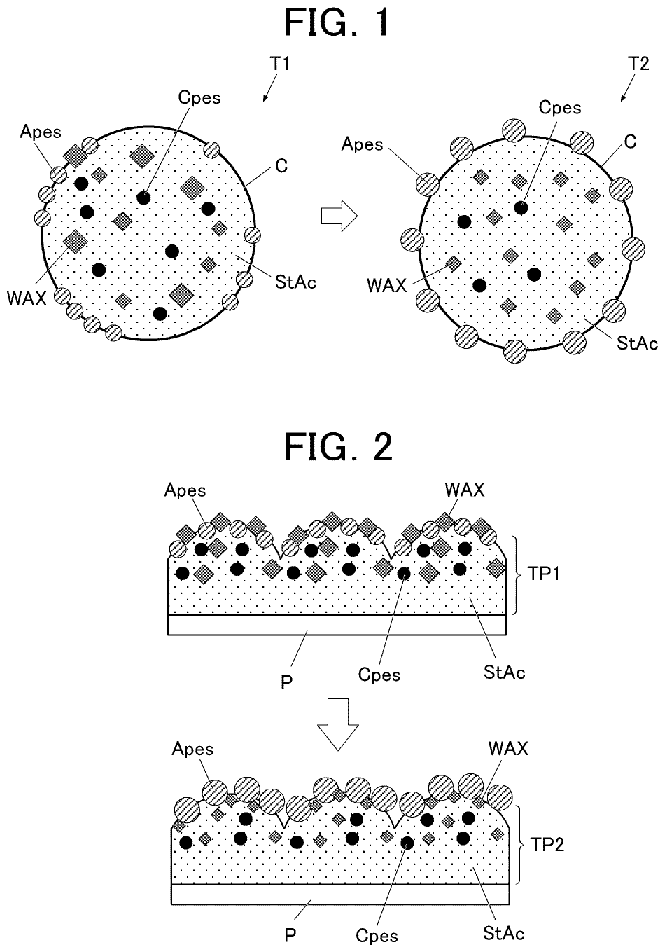

The influence of the structure of the toner base particles according to the present invention on the present invention will be described. FIG. 1 is an example of a schematic diagram illustrating differences between conventional toner base particles and toner base particles according to the present invention.

In FIG. 1, “T1” represents a conventional toner base particle, and “T2” represents a toner base particle according to the present invention. In addition, reference signs in T1 and T2 are common, and “C” represents a core particle, “WAX” represents wax, “Apes” represents amorphous polyester, “Cpes” represents crystalline polyester, and “StAc” represents styrene-acrylic resin.

First, the structure of toner base particles contained in a normal toner produced by a conventionally known method will be described. Hereinafter, the “normal toner produced by a conventionally known method” may be simply referred to as a “conventional toner”, and the “toner base particles contained in the conventional toner” may be simply referred to as “conventional toner base particles”.

In the following description, for the sake of convenience, the structure of conventional toner base particles and the structure of toner base particles according to the present invention are limited to the core-shell structure, and the constituent components are also limited, but the structure of toner base particles according to the present invention is not limited thereto.

It can be said that the affinity between the amorphous polyester Apes used in the shell and the wax WAX is considerably lower than the affinity between the crystalline polyester Cpes that is one of the constituent components of the core particle C and the wax WAX, from the viewpoint of the solubility parameter.

Therefore, it is considered that when the wax WAX is contained in the core particle C, as the particle diameter of the wax WAX is larger or as the content of the wax WAX is larger, the amorphous polyester Apes that is the shell does not easily fit with the core particle C.

The toner used in the image forming method according to the present invention has excellent fixing separability although the content of the wax WAX is the same as that of the wax of the conventional toner. The toner has been subjected to component preparation and structural adjustment for obtaining a fixed image excellent in applicability of a liquid to the fixed image and adhesiveness of the liquid to the fixed image.

In the toner base particle T2 according to the present invention, the content of the wax WAX is the same as that in the conventional toner base particle T1, but the particle diameter of the wax WAX is smaller than that in the conventional toner base particle T1, and the particle diameter of the amorphous polyester Apes is larger than that in the conventional toner base particle T1. Thus, the adverse effect of the wax WAX having a low affinity for the amorphous polyester Apes on the toner base particle is reduced, and the area of the amorphous polyester Apes attached to the core particle C is increased.

In a case where the core particle C of the toner base particle T2 is constituted by the styrene-acrylic resin StAc, the amorphous polyester Apes used in the shell and the styrene-acrylic resin StAc have high affinity with each other, and thus the shell tends to fit with the core particle C.

The content of the crystalline polyester Cpes can be reduced from that in the conventional toner base particle T1 by an amount corresponding to the compatibility of the shell with the core particle C. Note that in the toner base particle T2 according to the present invention, an exposed portion of the amorphous polyester Apes used in the shell onto the surface of the core particle C is increased in accordance with the decreased amount of the crystalline polyester Cpes.

When a toner containing toner base particles, such as the toner base particles T2 according to the present invention, in which the amorphous polyester Apes is more exposed on the surface of the core particles C as compared with the conventional toner base particles T1 is used for image formation, the amorphous polyester Apes is less likely to be embedded in the toner image.

FIG. 2 is an example of a schematic diagram illustrating differences between a conventional fixed image and a fixed image formed by the image forming method of the present invention. In FIG. 2, “P” represents a recording medium, “TP1” represents a conventional fixed image, and “TP2” represents a fixed image according to the present invention. Note that the “conventional fixed image” is a fixed image formed by using a conventional toner, and the “fixed image according to the present invention” is a fixed image formed by using the toner according to the present invention.

As compared with the conventional fixed image TP1, in the fixed image TP2 according to the present invention, the amorphous polyester Apes is less likely to be embedded in the fixed image TP2 and is exposed on the surface of the fixed image SL.

A case where the fixed image TP2 according to the present invention has a smaller content of the crystalline polyester Cpes than the conventional fixed image TP1 will be described.

The polar molecules in the amorphous polyester Apes in the fixed image TP2 according to the present invention are more likely to be oriented toward the outside of the fixed image than in the conventional fixed image TP1 due to the small amount of the crystalline polyester Cpes. Note that the “outside of the fixed image” is a side opposite to the recording medium P with reference to the fixed image in FIG. 2.

At the time of image formation, the wax WAX present in a finely dispersed state in the fixed image passes through the styrene-acrylic resin StAc and attempts to move to the surface of the fixed image from the gap of the amorphous polyester Apes. For this reason, the wax WAX is in a state of being interspersed between particles of the amorphous polyester Apes.

The presence of the wax WAX on the entire surface of the fixed image applies to both the fixed image T1 and the fixed image T2, and therefore the fixing separability does not change between the conventional fixed image T1 and the fixed image T2 according to the present invention. However, in the fixed image T2 according to the present invention, the particle diameter of the amorphous polyester Apes is larger than the particle diameter of the amorphous polyester Apes contained in the conventional fixed image T1, and therefore the wax WAX does not appear on the surface of the fixed image T2.

Therefore, the fixed image T2 according to the present invention has more amorphous polyester Apes and styrene-acrylic resin StAc on its surface as compared with the conventional fixed image T1. As a result, the functional group of the amorphous polyester and/or the styrene-acrylic resin is oriented in a large amount on the surface of the image, and the dispersion component and/or the polar component are increased.

Alternatively, the wax WAX is not present on the surface of the image in a sea-island shape but is present in a dispersed manner, and therefore the functional group of the amorphous polyester and/or the styrene-acrylic resin is oriented in a large amount on the surface of the image, and the dispersion component and/or the polar component are increased.

Such surface properties of the fixed image T2 are indicated by the above-described surface energy of the image, and the polar component γ^{p} of the surface energy of the image is equal to or more than 5 mN/m², and the dispersion component γ^{d} of the surface energy of the image is equal to or more than 20 mN/m².

### Method for Observing Section of Core-Shell Structure

The section of the core-shell structure can be confirmed by a known observation means such as a transmission electron microscope (TEM) or a scanning probe microscope (SPM). The “TEM” is an abbreviation for

Transmission Electron Microscope. The “SPM” is an abbreviation for Scanning Probe Microscope.

### Method for Producing Toner

In the case where the structure of the toner base particles is a core-shell structure, the core particles and the shell layer can have properties such as a glass transition point, a melting point, and hardness, different from each other, and the toner particles can be designed according to the purpose.

When the toner is produced, for example, a binder resin, a coloring agent, a release agent, and the like are contained in the toner base particles. It is preferable that a resin having a relatively high glass transition point (Tg) is aggregated and fused on the surface of the core particles having a relatively low glass transition point (Tg) to form the shell layer.

A method for producing a toner containing toner base particles having a core-shell structure is described in, for example, Japanese Unexamined Patent Publication No. 2016-161780.

The toner base particles having a core-shell structure are obtained, for example, by emulsion aggregation. In the emulsion aggregation method, toner base particles are prepared by the following procedure.

Binder resin microparticles for core particles, a crystalline substance, and a coloring agent are aggregated and fused to produce core particles. Next, a dispersion of core particles is prepared, and binder resin microparticles for a shell layer are added to the dispersion of core particles, so that the binder resin microparticles for a shell layer are aggregated and fused on the surface of the core particles, thereby forming a shell layer covering the surface of the core particles. Thus, toner base particles having a core-shell structure are produced.

The toner base particles according to the present invention may have a domain-matrix structure. The “domain-matrix structure” may be referred to as a “sea-island structure” and refers to a structure in which an island-shaped dispersed phase (domain) having a closed interface is present in a continuous phase (matrix) of the toner base particles. The above-described “matrix” corresponds to the “sea” of the “sea-island structure”. The “closed interface” is a “boundary between phases”.

The toner base particles having a domain-matrix structure may be in a state where, for example, there is a portion where the amorphous polyester resin or the hybrid amorphous polyester resin is introduced in an immiscible manner into the amorphous resin. In the toner base particles according to the present invention, wax or the like, which is a release agent, is added to the domain or the matrix in addition to the resin.

The “domain” may contain a lamellar crystal structure, and the structure of the toner base particles can be observed under the following conditions using an electronic microscope “JSM-7401F” manufactured by JEOL Ltd.

### Conditions

Sample: Slice of toner particles stained with ruthenium tetroxide (RuO₄) (slice thickness: 60 to 100 nm).
Acceleration voltage: 30 kV
Magnification: 50000 times
Observation conditions: transmission electron detector, bright-field image

In the case where the toner base particles have a domain-matrix structure, the average diameter of the domains is preferably in a range of 50 to 150 nm. Here, the “average diameter of the domains” refers to the average value of the longer diameters of the domains.

The average diameter of the domains can be measured by observing and analyzing, with an electronic microscope and an image processor/analyzer, the domains dyed by the method described in the conditions for observing the structure of the toner base particles with the electronic microscope “JSM-740IF”.

Examples of the electron microscope and the image processor/analyzer include “LUZEXR® AP” manufactured by Nireco Corporation.

### 3. Components of Toner Base Particles

The electrostatic charge image developing toner according to the present invention includes toner base particles containing at least a release agent. The toner base particles may contain, in addition to the release agent, other constituent components such as a binder resin, a coloring agent, and a charge control agent. The toner according to the present invention includes toner particles including toner base particles and an external additive disposed on the surface of the toner base particles.

In the present specification, the term “toner base particles” refers to the base of “toner particles”. The “toner base particles” are referred to as the “toner particles” by addition of an external additive. The “toner” refers to “an aggregate of toner particles”.

### (3.1) Release Agent

The release agent is contained in the toner used at the time of fixed image formation in order to improve offset resistance and fixing separability. When the release agent is contained in the toner base particles, the release agent exudes from the toner base particles at the time of forming a fixed image. Thus, the toner releasability in the formation of a fixed image is enhanced, and a higher-quality image can be obtained.

In particular, a release agent such as wax has low affinity for a liquid substance (liquid) such as general varnish having a polar group, due to its nature. If a low surface energy component such as wax is contained in the toner as a release agent, when a liquid is applied to a fixed image, the fixed image formed by using the toner easily repels the liquid, and thus the liquid is less likely to be uniformly wet-spread. That is, the applicability of the liquid to the image deteriorates, the wax bleeds on the surface of the fixed image, and the fixed image having a low surface energy is formed.

Wax is used as the release agent according to the present invention. Examples of the wax include ester-based waxes and hydrocarbon-based waxes. These waxes may be contained in combination in the toner base particles. The toner base particles may further contain a release agent other than those described above, such as an amide wax.

It is preferable that the toner base particles contain an ester-based wax as a release agent from the viewpoint of improving toner releasability from a fixed image. Since the toner base particles do not contain a hydrocarbon-based wax as a release agent, the toner releasability is improved.

Therefore, it is preferable that not the ester-based wax and the hydrocarbon-based wax in combination but the ester-based wax alone is contained in the toner base particles, from the viewpoint of improving toner releasability from a fixed image.

### (3.1.1) Ester-Based Wax

The toner base particles according to the present invention preferably contain an ester wax as a release agent from the viewpoint of improving toner releasability with respect to a fixed image. Since the ester wax has polar molecules, when the amorphous polyester is contained as a binder resin contained in the toner base particles, the affinity is higher and the compatibility is better than when the styrene-acrylic resin is contained as the binder resin.

Therefore, when the toner base particles contain the amorphous polyester as the binder resin, the ester wax is likely to be uniformly interspersed on the surface of the fixed image. Therefore, a smaller amount of wax can maximally secure the toner releasability that is an advantage of wax.

Therefore, even when the amount of the wax used at the time of forming a fixed image is the same, it is possible to secure more excellent fixing separability in the case of using the ester wax than in the case of using the wax other than the ester wax.

The ester-based wax is not particularly limited, and examples thereof include monoester-based wax, diester-based wax, triester-based wax, tetraester-based wax, and wax having five or more ester bonds.

Examples of the ester-based wax include behenyl behenate, triglycerol behenate, pentaerythritol tetrastearate, stearyl stearate, pentaerythritol tetrabehenate, ethylene glycol stearate, ethylene glycol behenate, neopentyl glycol stearate, neopentyl glycol behenate, 1,6-hexanediol stearate, 1,6-hexanediol behenate, glycerin stearate, glycerin behenate, stearyl citrate, behenyl citrate, stearyl furoate, and behenyl furoate.

Note that the ester-based wax may be a natural wax such as carnauba wax.

### (3.1.2) Hydrocarbon-Based Wax

The hydrocarbon-based wax is not particularly limited, and examples thereof include polyolefin waxes such as polyethylene wax and polypropylene wax, microcrystalline wax, paraffin wax, and Fischer-Tropsch wax.

### (3.1.3) Melting Point

The wax has a melting point of preferably 60° C. or more, more preferably 70° C. or more, and preferably 140° C. or less, more preferably 120° C. or less, still more preferably 100° C. or less. Thus, a balance between heat-resistant storage property and fixability and toner manufacturability can be ensured. Note that in a case where two or more types of waxes are used in combination, it is preferable that the melting point of each wax is within the above-described range.

### (3.1.4) Content

The content of the wax in the toner base particles is preferably in a range of 0.5 to 6 parts by mass with respect to the binder resin.

Wax tends to appear on the surface of an image at the time of toner fixing, and therefore if wax is contained in toner base particles contained in the toner used at the time of image formation, the fixing separability is improved, but the surface energy of the image is reduced. However, in the present invention, a high-quality image can be formed by increasing the surface energy of the image and controlling it to be in a specific range.

### (3.2) Binder Resin

The “binder resin” refers to a resin which is used as a medium or a matrix (base material) for dispersing and holding an internal additive and an external additive contained in toner particles and has a function of adhering to a recording medium at the time of a fixing process of a toner image. Examples of the internal additive include a release agent, a charge control agent, and a coloring agent. Examples of the external additive include silica and titanium oxide.

As the binder resin contained in the toner base particles according to the present invention, a conventionally known binder resin can be used, and examples of the binder resin include a crystalline resin and an amorphous resin.

### (3.2.1) Crystalline Resin

The “crystalline resin” refers to a resin having a clear endothermic peak, not a stepwise endothermic change, in differential scanning calorimetry (DSC). Specifically, the “clear endothermic peak” means a peak having a half width of the endothermic peak of 15° C. or less when measured at a temperature increase rate of 10° C./min in differential scanning calorimetry (DSC).

The content of the crystalline resin with respect to the toner base particles is preferably in a range of 1 to 40% by mass and more preferably in a range of 7 to 15% by mass from the viewpoint of obtaining sufficient low-temperature fixability. One type of crystalline resin may be used, or two or more types thereof may be used.

In a case where the content of the crystalline resin is 0.5% by mass or more, a sufficient plasticizing effect is obtained, and low-temperature fixability becomes sufficient. In a case where the content of the crystalline resin is 20% by mass or less, thermal stability and stability against physical stress as a toner become sufficient.

The crystalline resin is not particularly limited, and examples thereof include polyolefin, polydiene, and polyester. Among these, crystalline polyester is preferable from the viewpoint of obtaining sufficient low-temperature fixability and gloss uniformity and case of use.

The number average molecular weight (Mn) of the crystalline resin is preferably within a range of 2500 to 5000, and more preferably within a range of 3000 to 4500.

From the viewpoint of low-temperature fixability and gloss stability, the number average molecular weight (Mn) of the crystalline resin is preferably within a range of 3000 to 12500, and more preferably within a range of 4000 to 11000.

The weight average molecular weight (Mw) of the crystalline resin is preferably in the range of 10000 to 100000, more preferably in the range of 15000 to 80000, and still more preferably in the range of 20000 to 50000.

When the weight average molecular weight (Mw) and the number average molecular weight (Mn) are within the above ranges, a balance between fixability and heat resistance is easily achieved. In addition, sufficient strength is obtained in the fixed image. Furthermore, in the production of the toner, the crystalline resin is not pulverized during stirring of the emulsion and the glass transition temperature (Tg) of the toner is kept constant, so that the thermal stability of the toner is kept.

The weight average molecular weight (Mw) and the number average molecular weight (Mn) can be obtained from the molecular weight distribution measured by the above-described gel permeation chromatography (GPC).

### Crystalline Polyester

The crystalline polyester is obtained by a polycondensation reaction between a divalent or higher-valent carboxylic acid (polyvalent carboxylic acid) and a divalent or higher-valent alcohol (polyhydric alcohol).

The polyvalent carboxylic acid for obtaining the crystalline polyester is a divalent or higher-valent carboxylic acid, and may be, for example, a trivalent or higher-valent carboxylic acid such as trimellitic acid or pyromellitic acid. In light of crystallinity of the crystalline polyester, dicarboxylic acid is preferred. Examples of the dicarboxylic acid include aliphatic carboxylic acid and aromatic dicarboxylic acid.

Examples of the aliphatic carboxylic acid include oxalic, malonic, succinic, glutaric, adipic, pimelic, suberic, azelaic, sebacic, 1,9-nonanedicarboxylic, and 1,10-decanedicarboxylic acids. Examples thereof further include 1,11-undecanedicarboxylic acid, 1,12-dodecanedicarboxylic acid (dodecanedioic acid), and 1,13-tridecanedicarboxylic acid. Examples thereof further include 1,14-tetradecanedicarboxylic acid, 1,16-hexadecanedicarboxylic acid, and 1,18-octadecanedicarboxylic acid.

Examples of the aromatic dicarboxylic acid include terephthalic, isophthalic, orthophthalic, t-butylisophthalic, 2,6-naphthalenedicarboxylic, and 4,4′-biphenyldicarboxylic acid.

Note that the crystalline polyester may contain a structural unit derived from only one type of carboxylic acid among the above-described aliphatic carboxylic acids and aromatic dicarboxylic acids, or may include structures derived from two or more types of carboxylic acid.

From the viewpoint of exhibiting the effects of the present invention, aliphatic carboxylic acid is preferable. The number of carbon atoms of the linear hydrocarbon structure of the aliphatic carboxylic acid is preferably in a range of 6 to 16, and more preferably in a range of 10 to 14. The hydrocarbon structure of the aliphatic carboxylic acid may be partially branched. In this case, a hydrocarbon chain sandwiched between two carboxy groups is specified as a linear hydrocarbon structure.

The polyhydric alcohol for obtaining the crystalline polyester is a dihydric or higher-valent alcohol, and may be a trihydric or higher-valent alcohol such as glycerin, pentaerythritol, trimethylolpropane, or sorbitol. From the viewpoint of crystallinity of the crystalline polyester, a dihydric alcohol is preferable.

Examples of the dihydric alcohol include aliphatic diol, diol having an unsaturated double bond, and diol having a sulfonic acid group.

Examples of the aliphatic diol include ethylene glycol, 1,3-propanediol, 1,4-butanediol, 1,5-pentanediol, 1,6-hexanediol, 1,7-heptanediol, and 1,8-octanediol. Examples thereof further include 1,9-nonanediol, 1,10-decanediol, 1,11-undecanediol, 1,12-dodecanediol, and 1,13-tridecanediol. Examples thereof further include 1,14-tetradecanediol, 1,18-octadecanediol, and 1,20-eicosanediol.

Examples of the diol having a unsaturated double bond include 2-butene-1,4-diol, 3-hexene-1,6-diol, and 4-octene-1,8-diol.

### Content of Crystalline Polyester

The content of the crystalline polyester is preferably within a range of 0.5 to 5.0% by mass from the viewpoint of improving the adhesiveness of the liquid to a fixed image. It is more preferable that the content is in a range of 0.5 to 3.0% by mass from the same viewpoint.

The content of the crystalline polyester contained in the toner base particles included in the toner according to the present invention is less than the content in normal toner. Thus, when amorphous polyester is present on the surface of an image, polar molecules of the amorphous polyester are more likely to be oriented toward the outside of the surface of the fixed image, thereby improving the adhesiveness of liquid to the fixed image.

### Melting Point

The melting point of the crystalline polyester is preferably in a range of 50 to 85° C. from the viewpoint of sufficiently softening the toner particles to secure sufficient low-temperature fixability, and more preferably in a range of 60 to 80° C. from the viewpoint of improving various properties in a balanced manner.

The melting point of the crystalline polyester can be controlled by the structure of the resin (e.g., type of monomers).

### Molecular Weight

The weight average molecular weight (Mw) of the crystalline polyester is preferably in the range of 5000 to 50000, and the number average molecular weight (Mn) thereof is preferably in the range of 2000 to 10000. The crystalline polyester having the weight-average molecular weight (Mw) and the number-average molecular weight (Mn) in the above ranges contributes to a high low-temperature fixability.

### Manufacturing Method

The crystalline polyester can be produced by polycondensation (esterification) of the polyvalent carboxylic acid and the polyhydric alcohol using a known esterification catalyst.

One or more types of catalyst may be used in the production of the crystalline polyester. Examples of the catalyst include compounds of alkali metals such as sodium and lithium, and compounds containing Group 2 elements such as magnesium and calcium. Examples thereof further include metal compounds of aluminum, zinc, manganese, antimony, titanium, tin, zirconium, germanium, and so forth, a phosphorous acid compound, a phosphoric acid compound, and an amine compound.

The polymerization temperature of the crystalline polyester is preferably within a range of 150 to 250° C. The polymerization time is preferably within a range of 0.5 to 10 hours. During the polymerization, the pressure in the reaction system may be reduced as necessary.

### Hybrid Crystalline Polyester

In a case where the toner base particles according to the present invention contain a crystalline polyester, the crystalline polyester may be a hybrid crystalline polyester. When the crystalline polyester is a hybrid crystalline polyester, affinity with an amorphous resin used in combination is improved, and low-temperature fixability of the toner to an image is improved. In addition, since the dispersibility of the crystalline resin in the toner is improved, the bleed-out of the crystalline resin to the surface of a fixed image can be suppressed.

Hereinafter, the “hybrid crystalline polyester” may be referred to simply as a “hybrid resin”.

One or more types of hybrid resin may be used. Further, the hybrid resin may be substituted for the whole amount of the crystalline polyester, may be substituted for part of the crystalline polyester, or may be used in combination with the crystalline polyester.

The hybrid resin is a resin in which a crystalline polyester polymerization segment and an amorphous polymerization segment are chemically bonded.

The term “crystalline polyester polymerization segment” refers to a moiety derived from a crystalline polyester. That is, it means a molecular chain having the same chemical structure as the molecular chain constituting the crystalline polyester described above.

The term “amorphous polymerization segment” refers to a moiety derived from an amorphous resin. That is, it means a molecular chain having the same chemical structure as the molecular chain constituting the amorphous resin described later.

The constituent components of each polymerization segment in the toner and the contents thereof can be identified by using a known analysis method such as nuclear magnetic resonance (NMR) or methylation reaction pyrolysis gas chromatography/mass spectrometry (Py-GC/MS).

### Weight Average Molecular Weight

The weight average molecular weight (Mw) of the hybrid resin is preferably in a range of 5000 to 100000 from the viewpoint that both sufficient low-temperature fixability and excellent long-term storage stability can be reliably achieved. It is more preferably in a range of 7000 to 50000, and still more preferably in a range of 8000 to 20000.

When the weight average molecular weight (Mw) of the hybrid resin is 100000 or less, sufficient low-temperature fixability can be obtained. When the weight average molecular weight (Mw) of the hybrid resin is 5000 or more, excessive compatibilization of the hybrid resin and the amorphous resin during storage of the toner is suppressed, and image defects due to fusion between toner particles can be effectively suppressed.

### Crystalline Polyester Polymerization Segment

The crystalline polyester polymerization segment may be, for example, a resin having a structure in which another component is copolymerized with a main chain formed of the crystalline polyester polymerization segment, or a resin having a structure in which the crystalline polyester polymerization segment is copolymerized with a main chain formed of another component. The crystalline polyester polymerization segment can be produced from the above-described polyvalent carboxylic acid and polyhydric alcohol in the same manner as the crystalline polyester described above.

The constituent components of the crystalline polyester polymerization segment in the hybrid resin (or in the toner) and the contents thereof can be identified by using a known analysis method such as NMR or methylation reaction Py-GC/MS.

### Amorphous Polymerization Segment

The amorphous polymerization segment increases the affinity between the amorphous resin that constitutes the binder resin and the hybrid resin. Thus, the hybrid resin is more likely to be incorporated into the amorphous resin, which further improves the charging uniformity of the toner.

The amorphous polymerization segment is preferably composed of the same type of resin as the amorphous resin contained in the binder resin from the viewpoint of enhancing the affinity with the binder resin and enhancing the charging uniformity of the toner. By adopting such a form, the affinity between the hybrid resin and the amorphous resin is further improved, and the “same type of resin” means resins having a characteristic chemical bond in the repeating unit.

The “characteristic chemical bond” conforms to the “Polymer class” described in National Institute for Materials Science (NIMS) Material Database (http://polymer.nims.go.jp/PoLyInfo/guide/jp/term_polymer. html). That is, a chemical bond constituting a polymer classified into a total of 22 types, including polyacryl, polyamide, polyanhydride, polycarbonate, polydiene, polyester, polyhaloolefin, polyimide, polyimine, polyketone, polyolefin, polyether, polyphenylene, polyphosphazene, polysiloxane, polystyrene, polysulfide, polysulfone, polyurethane, polyurea, polyvinyl, and other polymers, is referred to as the “characteristic chemical bond”.

The “same type of resin” in a case where the resin is a copolymer means resins having a characteristic chemical bond in common in a case where a monomer species having the chemical bond is a constituent unit in a chemical structure of a plurality of monomer species constituting the copolymer. Therefore, even when resins themselves show different properties or when the molar component ratios of monomer species constituting a copolymer are different from each other, the resins are regarded as the same type of resin as long as the resins have a characteristic chemical bond in common.

For example, a resin (or polymerization segment) formed by styrene, butyl acrylate and acrylic acid and a resin (or polymerization segment) formed by styrene, butyl acrylate and methacrylic acid are the same type of resin because they have at least a chemical bond constituting polyacryl. Further, for example, a resin (or polymerization segment) formed by styrene, butyl acrylate and acrylic acid and a resin (or polymerization segment) formed by styrene, butyl acrylate, acrylic acid, terephthalic acid and fumaric acid have at least a chemical bond constituting polyacryl as a common chemical bond. Therefore, these are the same type of resin.

Examples of the amorphous polymerization segment include a vinyl polymerization segment, a urethane polymerization segment, and a urea polymerization segment. Among these, a vinyl polymerization segment is preferable from the viewpoint that thermoplasticity is easily controlled. The vinyl polymerization segment can be synthesized in the same manner as the vinyl resin according to the present invention.

The constituent components of the amorphous polymerization segment in the hybrid resin (or in the toner) and the contents thereof can be identified by using a known analysis method such as NMR or methylation reaction Py-GC/MS.

### Manufacturing Method

The hybrid resin can be produced, for example, by the following production methods (1) to (3). For details of the production method, refer to [0088] to [0099] of Japanese Unexamined Patent Publication No. 2020-197711.
(1) Method of producing a hybrid resin by performing a polymerization reaction for synthesizing a crystalline polyester polymerization segment in the presence of an amorphous polymerization segment synthesized in advance
(2) Method of producing a hybrid resin by forming a crystalline polyester polymerization segment and an amorphous polymerization segment and bonding these
(3) Method of producing a hybrid resin by performing a polymerization reaction for synthesizing an amorphous polymerization segment in the presence of a crystalline polyester polymerization segment

### (3.2.2) Amorphous Resin

The toner base particles according to the present invention preferably contain an amorphous resin, and the amorphous resin is preferably a styrene-acrylic resin from the viewpoint of the balance of thermal properties, exudation properties of a release agent, and compatibility with additives.

The “amorphous resin” is a resin that does not have crystallinity and is a resin that does not have a melting point and has a relatively high glass transition temperature (Tg) in differential scanning calorimetry (DSC).

The glass transition temperature (Tg) of the amorphous resin is preferably in a range of 35 to 80° C., especially preferably in a range of 45 to 65° C.

The glass transition temperature (Tg) can be measured in conformity with the method (DSC method) specified in ASTM (American Society for Testing and Materials) D3418-82. For the measurement of the glass transition temperature (Tg), a DSC-7 differential scanning calorimeter (manufactured by PerkinElmer, Inc.), a TAC7/DX thermal analyzer controller (manufactured by PerkinElmer, Inc.) or the like can be used.

One or more types of amorphous resin may be used. Examples of the amorphous resin include vinyl resin, urethane resin, urea resin, and amorphous polyester such as styrene-acrylic modified polyester.

The amorphous resin preferably contains a vinyl resin as a main component of the binder resin and also preferably contains an amorphous polyester, from the viewpoint of easy control of thermoplasticity.

The number average molecular weight (Mn) of the amorphous resin is preferably in the range of 5000 to 150000, and more preferably in the range of 8000 to 70000. The molecular weight of the amorphous resin can be measured in the same manner as the method for measuring the molecular weight distribution described above.

### Vinyl Resin

Examples of the vinyl resin include an acrylic acid ester resin, a styrene-acrylic acid ester resin, and an ethylene-vinyl acetate resin. Among these, from the viewpoint of plasticity at the time of heat fixing, a styrene-acrylic acid ester resin (styrene-acrylic resin) is preferable.

### Styrene-Acrylic Resin

The styrene-acrylic resin is formed by addition-polymerizing at least a styrene monomer and a (meth) acrylic acid ester monomer. The styrene monomer includes, in addition to styrene represented by the structural formula of CH₂=CH—C₆H₅, a styrene derivative having a known side chain or functional group in the styrene structure.

The (meth) acrylic acid ester monomer includes, in addition to an acrylic acid ester and a methacrylic acid ester represented by CH(R₁)=CHCOOR₂ (R₁ represents a hydrogen atom or a methyl group, and R₂ represents an alkyl group having 1 to 24 carbon atoms), an acrylic acid ester derivative and a methacrylic acid ester derivative having a known side chain or functional group in the structure of these esters.

Examples of the styrene monomer include styrene, o-methylstyrene, m-methylstyrene, p-methylstyrene, α-methylstyrene, p-phenylstyrene, p-ethylstyrene, and 2,4-dimethylstyrene. Examples thereof further include p-tert-butylstyrene, p-n-hexylstyrene, p-n-octylstyrene, p-n-nonylstyrene, p-n-decylstyrene, and p-n-dodecylstyrene.

Examples of the (meth) acrylic acid ester monomer include an acrylic acid ester monomer and a methacrylic acid ester.

Examples of the acrylic acid ester monomer include methyl acrylate, ethyl acrylate, isopropyl acrylate, n-butyl acrylate, t-butyl acrylate, isobutyl acrylate, and n-octyl acrylate. Examples thereof further include 2-ethylhexyl acrylate (2EHA), stearyl acrylate, lauryl acrylate, and phenyl acrylate.

Examples of the methacrylic acid ester include methyl methacrylate, ethyl methacrylate, n-butyl methacrylate, isopropyl methacrylate, isobutyl methacrylate, t-butyl methacrylate, and n-octyl methacrylate. Examples thereof further include 2-ethylhexyl methacrylate, stearyl methacrylate, lauryl methacrylate, phenyl methacrylate, diethylaminoethyl methacrylate, and dimethylaminoethyl methacrylate.

Note that in the present specification, the term “(meth) acrylic acid ester monomer” is a generic term for “acrylic acid ester monomer” and “methacrylic acid ester monomer”, and means one or both of them. For example, “methyl (meth) acrylate” means one or both of “methyl acrylate” and “methyl methacrylate”.

The (meth) acrylic acid ester monomer may be used alone or in combination of two or more types. For example, a copolymer can be formed by using a styrene monomer and two or more types of acrylic acid ester monomer. As another example, a copolymer can be formed by using a styrene monomer and two or more types of methacrylic acid ester monomer. As another example, a copolymer can be formed by using a styrene monomer, an acrylate ester monomer and a methacrylate ester monomer.

The styrene-acrylic resin can be synthesized by a method of polymerizing a monomer using a known oil-soluble or water-soluble polymerization initiator. Examples of the oil-soluble polymerization initiator include an azo-based polymerization initiator, a diazo-based polymerization initiator, and a peroxide-based polymerization initiator.

Examples of the azo-based polymerization initiator and the diazo-based polymerization initiator include 2,2′-azobis-(2,4-dimethyl valeronitrile), 2,2′-azobisisobutyronitrile, and 1,1′-azobis (cyclohexane-1-carbonitrile). Examples thereof further include 2,2′-azobis-4-methoxy-2,4-dimethyl valeronitrile, and azobisisobutyronitrile.

Examples of the peroxide-based polymerization initiator include benzoyl peroxide, methyl ethyl ketone peroxide, diisopropyl peroxycarbonate, cumene hydroperoxide, and t-butyl hydroperoxide. Examples thereof further include di-t-butyl peroxide, dicumyl peroxide, and 2,4-dichlorobenzoyl peroxide. Examples thereof further include lauroyl peroxide, 2,2-bis-(4,4-t-butylperoxycyclohexyl) propane, and tris-(t-butylperoxy) triazin.

In the case where the resin particles of the styrene-acrylic resin are synthesized by the emulsion polymerization method, a water-soluble radical polymerization initiator can be used as the polymerization initiator. Examples of the water-soluble polymerization initiator include persulfates such as potassium persulfate and ammonium persulfate. Examples thereof further include azobisaminodipropane acetate, azobiscyanovaleric acid and a salt thereof, and hydrogen peroxide.

The amorphous resin may further contain a constituent unit derived from a monomer other than the styrene monomer and the (meth) acrylic acid ester monomer. The other monomer is preferably a compound that forms an ester bond with a hydroxy group (—OH) derived from a polyhydric alcohol or a carboxy group (—COOH) derived from a polyvalent carboxylic acid. That is, the amorphous resin is preferably a polymer obtained by polymerization of a compound (amphoteric compound) that is addition-polymerizable with the styrene monomer and the (meth) acrylate ester monomer and has a carboxy group or a hydroxy group.

Examples of the amphoteric compound include a compound having a carboxy group and a compound having a hydroxy group.

Examples of the compound having a carboxy group include acrylic acid, methacrylic acid, maleic acid, itaconic acid, cinnamic acid, fumaric acid, maleic acid monoalkyl ester, and itaconic acid monoalkyl ester.

Examples of the compound having a hydroxy group include 2-hydroxyethyl (meth) acrylate, 2-hydroxypropyl (meth) acrylate, 3-hydroxypropyl (meth) acrylate, and 2-hydroxybutyl (meth) acrylate. Examples thereof further include 3-hydroxybutyl (meth) acrylate, 4-hydroxybutyl (meth) acrylate, and polyethylene glycol mono (meth) acrylate.

### Amorphous Polyester

In the case where the toner base particles are those have a core-shell structure, the amorphous polyester is preferably used in the shell from the viewpoint of excellent heat resistance without inhibiting the fixability. The amorphous polyester is polyester, and is a resin which does not have a melting point and has a relatively high glass transition temperature (Tg) in differential scanning calorimetry (DSC). Since the monomer constituting the amorphous polyester is different from the monomer constituting the crystalline polyester, the amorphous polyester can be distinguished from the crystalline polyester by, for example, an analysis method such as NMR.

The amorphous polyester is obtained by a polycondensation reaction between a divalent or higher-valent carboxylic acid (polyvalent carboxylic acid) and a divalent or higher-valent alcohol (poly hydric alcohol). The amorphous polyester is not particularly limited, and a conventionally known amorphous polyester in the present technical field can be used.

A specific method for producing the amorphous polyester is not particularly limited, and the resin can be produced by polycondensation (esterification) of a polyvalent carboxylic acid and a polyhydric alcohol using a known esterification catalyst.

The catalyst that can be used in the production, the temperature of polycondensation (esterification), and the time of polycondensation (esterification) are not particularly limited, and are the same as those for the crystalline polyester described above.

### (3.3) Others

### Coloring Agent

The coloring agent to be contained in the toner base particles according to the present invention is not particularly limited, and for example, various known pigments and dyes can be used, and these may be used in combination.

One or more types of coloring agent may be used. Typical coloring agents include, for example, a coloring agent for magenta, a coloring agent for yellow, a coloring agent for cyan, and a coloring agent for black.

Examples of the coloring agent for magenta include C. I. Pigment Red 2, 3, 5, 6, 7, 15, 16, 48:1, 53:1, 57:1, 60, 63, 64, 68, 81, 83, 87, 88, 89, and 90. Examples thereof further include C. I. Pigment Red 112, 114, 122, 123, 139, 144, 149, 150, 163, 166, 170, 177, 178, 184, 202, 206, 207, 209, 222, 238, and 269.

Examples of the coloring agent for yellow include C. I. Pigment Orange 31 and 43, and C. I. Pigment Yellow 12, 14, 15, 17, 74, 83, 93, 94, 138, 155, 162, 180, and 185.

Examples of the coloring agent for cyan include C. I. Pigment Blue 2, 3, 15, 15:2, 15:3, 15:4, 16, 17, 60, 62, 66, and C. I. Pigment Green 7.

Examples of the coloring agent for black include carbon black and magnetic particles.

Examples of the carbon black include channel black, furnace black, acetylene black, thermal black, and lamp black.

Examples of the magnetic substance of the magnetic particles include ferromagnetic metals such as iron, nickel, and cobalt. Examples thereof further include an alloy containing any of these metals. Examples thereof further include compounds of ferromagnetic metals, such as ferrite and ferromagnetic. Examples thereof further include chromium dioxide, and an alloy which does not contain a ferromagnetic metal but exhibits ferromagnetism by heat treatment.

Examples of the alloy that exhibits ferromagnetism by heat treatment include Heusler alloys such as manganese-copper-aluminum and manganese-copper-tin.

The content of the coloring agent in the toner base particles can be appropriately and independently determined, and is, for example, preferably in the range of 1 to 30% by mass, and more preferably in the range of 2 to 20% by mass, from the viewpoint of ensuring color reproducibility of an image.

The particle size of the coloring agent is, for example, preferably within a range of 10 to 1000 nm, more preferably within a range of 50 to 500 nm, and still more preferably within a range of 80 to 300 nm in terms of volume average particle diameter.

The volume average particle diameter may be a catalog value, and for example, the volume average particle diameter (volume-based median diameter) of a coloring agent can be measured with “UPA-150” (manufactured by MicrotracBEL Corp.).

### Charge Control Agent

The charge control agent to be contained in the toner base particles according to the present invention is not particularly limited, and various known compounds can be used. Examples thereof include nigrosine-based dyes, metal salts of naphthenic acid and higher fatty acids, and alkoxylated amines. Examples thereof further include a quaternary ammonium salt compound, an azo-based metal complex, and a salicylic acid metal salt.

The content of the charge control agent is usually within a range of 0.1 to 10 mass % with respect to the finally obtained toner base particles. Furthermore, the content of the charge control agent is preferably within a range of 0.5 to 5 mass %.

The size of the charge control agent particles is usually within a range of 10 to 1000 nm in terms of number average primary particle diameter. Furthermore, the size of the charge control agent particles is preferably within a range of 50 to 500 nm, and more preferably within a range of 80 to 300 nm.

### External Additive

The toner particles can be used as a toner as they are, but may be treated with an external additive(s) such as a fluidizing agent and a cleaning aid in order to improve fluidity, charging property, cleaning property and the like.

Examples of the external additive include inorganic oxide microparticles, inorganic stearic acid compound microparticles, and inorganic titanic acid compound microparticles. These can be used singly or in combination of two or more types thereof.

Examples of the inorganic oxide microparticles include silica microparticles, alumina microparticles, and titanium oxide microparticles.

Examples of the inorganic stearic acid compound microparticles include aluminum stearate microparticles and zinc stearate microparticles.

Examples of the inorganic titanic acid compound microparticles include strontium titanate and zinc titanate.

From the viewpoint of improving heat-resistant storage property and environmental stability, these external additives are preferably subjected to surface treatment with a silane coupling agent, a titanium coupling agent, a higher fatty acid, silicone oil, or the like.

The amount of the external additive to be added is preferably in a range of 0.05 to 5 parts by mass and more preferably in a range of 0.1 to 3 parts by mass with respect to the toner base particles.

### 4. Physical Properties, etc. of Toner Particles

### Particle Diameter of Toner Particles

Regarding the average particle diameter of the toner particles, the volume-based median diameter (d₅₀) is preferably in a range of 3 to 15 μm and more preferably in a range of 4 to 8 μm. When the average particle diameter of the toner particles is within such a range, high reproducibility is obtained even in the case of an extremely minute dot image at the 1200 dpi level. Note that the average particle diameter of the toner particles can be controlled by the concentration of the aggregating agent used in the production, the amount of the organic solvent to be added, the fusion time, the composition of the binder resin, and the like.

For the measurement of the volume-based median diameter (d₅₀) of the toner particles, for example, a measuring apparatus in which a computer system equipped with data processing software Software V3.51 is connected to “Multisizer 3” manufactured by Beckman Coulter, Inc. can be used. A successor “Multisizer IV” of “Multisizer 3” may be used.

The average particle diameter of the toner particles can be measured, for example, as follows.

A measurement sample (toner) is added to a surfactant solution and mixed, and then ultrasonic dispersion is performed to prepare a toner particle dispersion. Note that the surfactant solution may be, for example, a surfactant solution prepared by diluting a neutral detergent containing a surfactant component with pure water by a factor of 10 for the purpose of dispersing the toner particles.

The above toner particle dispersion is poured with a pipette into a beaker containing ISOTONII (manufactured by Beckman Coulter, Inc.) in a sample stand, until the concentration indicated on the measuring apparatus becomes 8%. With this concentration, reproducible measurement values can be obtained.

Next, in the measurement apparatus, under conditions where the number of measurement particles to be counted is 25000 and the aperture diameter is 100 μm, a frequency value is calculated by dividing the range of 2 to 60 μm, which is the measurement range, into 256 sections. Then, the particle diameter at 50% from the larger volume cumulative fraction is obtained as the volume-based median diameter (d₅₀).

### Average Circularity of Toner Particles

The average circularity of toner particles is preferably in the range of 0.930 to 1.000, and more preferably in the range of 0.950 to 0.995, from the viewpoint of enhancing the stability of charging properties and low-temperature fixability.

When the average circularity is within the above range, individual toner particles are less likely to be crushed. Thus, contamination of the triboelectric charging member can be suppressed to stabilize the chargeability of the toner and enhance the quality of the image formed.

The average circularity of the toner particles can be measured using, for example, FPIA-3000 (manufactured by Sysmex Corporation).

The average circularity of the toner particles is measured, for example, as follows.

A measurement sample (toner) is wetted with an aqueous solution containing a surfactant, and subjected to ultrasonic dispersion treatment for 1 minute for dispersion. Thereafter, imaging is performed with FPIA-3000 (manufactured by Sysmex Corporation) under measurement conditions of an HPF (high power field imaging) mode at an appropriate concentration corresponding to an HPF detection number of 3000 to 10000.

When the HPF detection number is within the above range, a reproducible measurement value can be obtained. From the captured particle image, the circularity of each toner particle is calculated according to the following formula (I), and the average circularity is obtained by adding the values of the circularity of the toner particles and dividing the result by the total number of toner particles.

$$Circularity of Toner Particle = ( Perimeter of Circle having Same Projected Area as Particle Image ) / ( Perimeter of Particle Projected Image ) \qquad Formula ( I )$$

### 5. Steps in Image Forming Method

The image forming method of the present invention is not particularly limited as long as it includes a step of forming an image on a recording medium using an electrostatic charge image developing toner. The image forming method may include, for example, the following steps (1) to (3).
(1) Step of producing an electrostatic charge image developing toner
(2) Step of forming an image on a recording medium using the electrostatic charge image developing toner
(3) Step of winding the recording medium with a fixed image formed

Hereinafter, details of the image forming method will be described in the order of the above (1) to (3).

### (5.1) Step of Producing Electrostatic Charge Image Developing Toner

Examples of the method for producing the toner according to the present invention include a kneading and pulverizing method, an emulsion dispersion method, a suspension polymerization method, a dispersion polymerization method, an emulsion polymerization method, an emulsion polymerization aggregation method, a mini-emulsion polymerization aggregation method, an encapsulation method, and other known methods.

Considering that it is necessary to obtain a toner having a reduced particle diameter in order to achieve high image quality, the emulsion polymerization aggregation method is preferably used from the viewpoint of production cost and production stability.

The emulsion polymerization aggregation method is a method for producing a toner by the following procedure.

A dispersion of microparticles made of a binder resin produced by an emulsion polymerization method is mixed with a dispersion of microparticles made of a coloring agent to prepare a mixed liquid. Hereinafter, the “microparticles made of a binder resin” may be simply referred to as “binder resin microparticles”. The “microparticles made of a coloring agent” may be referred to as “coloring agent microparticles”.

Next, in the mixed liquid, microparticles are slowly aggregated while a balance is maintained between the repulsive force of the surface of the microparticles due to the pH adjustment and the aggregation force due to the addition of the aggregating agent made of an electrolyte body. Association is performed while the average particle diameter and the particle diameter distribution are controlled, and at the same time, the fusion between the microparticles is performed by heating and stirring to control the shape. The toner is produced by such a procedure.

In the method of producing the toner, the binder resin microparticles formed in the case of using the emulsion polymerization aggregation method may have a configuration of two or more layers made of binder resins having different compositions. In this case, a method can be adopted in which a polymerization initiator and a polymerization monomer are added to a dispersion of first binder resin microparticles prepared by emulsion polymerization treatment (first stage polymerization) according to a conventional method, and this system is subjected to polymerization treatment (second stage polymerization).

Furthermore, the toner may have a core-shell structure, and a method for producing the toner having the core-shell structure is performed by the following procedure.

Binder resin microparticles for the core and a coloring agent microparticles are associated, aggregated, and fused to produce core particles. Next, binder resin microparticles for the shell for forming a shell layer are added to the dispersion of the core particles, and the binder resin microparticles for the shell are aggregated and fused onto the surface of the core particles to form a shell layer covering the surface of the core particles. A toner having a core-shell structure can be produced by such a procedure.

For the case where the toner has a core-shell structure, the method for producing the toner will be specifically described below in (1) to (9).
(1) Coloring agent microparticle dispersion preparation step of preparing a dispersion of coloring agent microparticles in which a coloring agent is dispersed in the form of microparticles
(2-1) Core binder resin microparticle polymerization step of obtaining core binder resin microparticles made of a core binder resin containing a main wax, an internal additiv(s) and the like and preparing a dispersion thereof
(2-2) Shell binder resin microparticle polymerization step of obtaining shell binder resin microparticles made of a shell binder resin and preparing a dispersion thereof
(3) Aggregation and fusion step of aggregating and fusing the core binder resin microparticles and the coloring agent microparticles in an aqueous medium to form associated particles that are be core particles
(4) First aging step of aging the associated particles with thermal energy to control their shapes and obtain core particles
(5) Shell layer formation step of adding the shell binder resin microparticles, which are to form a shell layer, to the dispersion of the core particles and aggregating and fusing the shell binder resin microparticles on surface of the core particles to form particles having a core-shell structure
(6) Second aging step of aging the particles having a core-shell structure with thermal energy to control their shapes and obtaining toner particles having a core-shell structure
(7) Filtration and washing step of performing solid-liquid separation to extract the toner particles from the cooled dispersion (aqueous medium) of the toner particles and removing a surfactant and the like from the toner particles
(8) Drying step of drying the washed toner particles
(9) External additive treatment step of adding an external additive to the dried toner particles (optional step)

### (1) Coloring Agent Microparticle Dispersion Preparation Step

In this step, a coloring agent is added to an aqueous medium and subjected to dispersion treatment with a disperser, to prepare a dispersion of coloring agent microparticles in which the coloring agent is dispersed in the form of microparticles.

Specifically, the dispersion treatment of the coloring agent is performed in an aqueous medium in a state where the surfactant concentration is set to be equal to or higher than the critical micelle concentration (CMC).

The disperser used for the dispersion treatment is not particularly limited, but preferred examples thereof include pressure dispersing machines such as an ultrasonic dispersing machine, a mechanical homogenizer, Manton-Gaulin, and a pressure homogenizer, and medium dispersing machines such as a sand grinder, a Getzmann mill, and a diamond fine mill.

The diameter of the coloring agent microparticles in the coloring agent microparticle dispersion is preferably in the range of 40 to 200 nm in terms of volume-based median diameter.

The volume-based median diameter of the coloring agent microparticles is measured by using “MICROTRAC UPA-150 (manufactured by Honeywell International Inc.)” under the following measurement conditions.

### Measurement Conditions

Sample refractive index: 1.59
Specific gravity of sample: 1.05 (in terms of spherical particles)
Solvent refractive index: 1.33
Solvent viscosity: 0.797 (30° C.), 1.002 (20° C.)
Zero point adjustment: Ion exchanged water is put into measurement cell for adjustment.

### (2-1) Core Binder Resin Microparticle Polymerization Step

In this step, a polymerization treatment is carried out to prepare a dispersion of core binder resin microparticles made of a core binder resin containing a main wax, an internal additive(s) and the like.

In a preferable example of the polymerization treatment in this step, a polymerization monomer solution containing a main wax, an internal additive and the like as needed is added to an aqueous medium containing a surfactant at a critical micelle concentration (CMC) or less, mechanical energy is applied thereto to form droplets, and then a water-soluble polymerization initiator is added, to allow polymerization reaction to proceed in the droplets.

Note that an oil-soluble polymerization initiator may be contained in the droplets.

In this step, a treatment of applying mechanical energy to perform forced emulsification (formation of droplets) is essential. Examples of the means for applying mechanical energy include means for applying strong stirring or ultrasonic vibration energy, such as a homomixer, ultrasonic waves, and Manton-Gaulin.

### Surfactant

The surfactant used in the aqueous medium used at the time of polymerization of the coloring agent microparticle dispersion and/or the core binder resin microparticles will be described.

The surfactant that can be suitably used is not particularly limited, and examples thereof include ionic surfactants such as a sulfonate, a sulfate ester salt, and a fatty acid salt.

Examples of the sulfonate include sodium dodecylbenzene sulfonate and sodium arylalkyl polyether sulfonate.

Examples of the sulfate ester salt include sodium dodecyl sulfate, sodium tetradecyl sulfate, sodium pentadecyl sulfate, and sodium octyl sulfate.

Examples of the fatty acid salt include sodium oleate, sodium laurate, sodium caprate, sodium caprylate, sodium caproate, potassium stearate, and calcium oleate.

As the surfactant, a nonionic surfactant can also be used. Examples of the nonionic surfactant include polyethylene oxide, polypropylene oxide, and a combination of polypropylene oxide and polyethylene oxide.

Examples thereof further include an ester of polyethylene glycol and a higher fatty acid, and alkylphenol polyethylene oxide. Examples thereof further include an ester of a higher fatty acid and polyethylene glycol, an ester of a higher fatty acid and polypropylene oxide, a sorbitan ester.

Hereinafter, the polymerization initiator and the chain transfer agent to be used in the core binder resin microparticle polymerization step will be described.

### Polymerization Initiator

Examples of the water-soluble polymerization initiator include persulfates such as potassium persulfate and ammonium persulfate, azobisaminodipropane acetate, azobiscyanovaleric acid and salts thereof, and hydrogen peroxide.

Examples of the oil-soluble polymerization initiator include azo-based or diazo-based polymerization initiators such as 2,2′-azobis-(2,4-dimethyl valeronitrile), 2,2′-azobisisobutyronitrile, 1,1′-azobis (cyclohexane-1-carbonitrile), 2,2′-azobis-4-methoxy-2,4-dimethyl valeronitrile and azobisisobutyronitrile, peroxide-based polymerization initiators such as benzoyl peroxide, methyl ethyl ketone peroxide, diisopropylperoxycarbonate, cumenehydroperoxide, t-butylhydroperoxide, di-t-butylperoxide, dicumyl peroxide, 2,4-dichlorobenzoyl peroxide, lauroyl peroxide, 2,2-bis-(4,4-t-butylperoxycyclohexyl) propane and tris-(t-butylperoxy) triazin and polymer initiators having a peroxide in the side chain.

### Chain Transfer Agent

For the purpose of adjusting the molecular weight of the binder resin for the core to be obtained, a generally used chain transfer agent can be used.

The chain transfer agent is not particularly limited, and examples thereof include n-octyl mercaptan and n-decyl mercaptan. Examples thereof further include mercaptans such as tert-dodecyl mercaptan, mercaptopropionic acid esters such as n-octyl-3-mercaptopropionic acid ester, terpinolene, and α-methylstyrene dimer.

### (2-2) Shell Binder Resin Microparticle Polymerization Step

The particle diameter of the amorphous polyester can be controlled by changing the reaction conditions at the time of polymerization in the preparation of the dispersion of the shell binder resin microparticles.

In this step, a polymerization treatment is carried out in the same manner as in the core binder resin microparticle polymerization step (2-1) described above, to prepare a dispersion of shell binder resin microparticles made of a shell binder resin.

### Volume Average Particle Diameter of Resin Particles

The volume average particle diameter of the resin particles dispersed in the resin particle dispersion is, for example, preferably in a range of 0.01 to 1 μm, more preferably in a range of 0.08 to 0.8 μm, and still more preferably in a range of 0.1 to 0.6 μm. The volume average particle diameter of the resin particles can be measured by a laser diffraction particle size distribution analyzer.

Example of the laser diffraction particle size distribution analyzer include “LA-700” (manufactured by Horiba, Ltd.). Using the particle size distribution obtained by measurement with the above-described analyzer, a cumulative distribution is drawn from the small particle diameter side for the volume with respect to the divided particle size ranges (channels). Then, the particle diameter at which the cumulative percentage is 50% with respect to all the particles is measured as the volume average particle diameter D₅₀v. Note that the volume average particle diameter of particles in other dispersions is measured in the same manner.

### (3) Aggregation and Fusion Step

In this step, the core binder resin microparticles and the coloring agent microparticles are aggregated and fused in an aqueous medium to form associated particles which are to be core particles.

The method of aggregation and fusion in this step is preferably a salting-out/fusion method using the coloring agent microparticles obtained in the coloring agent microparticle dispersion preparation step (1) and the core binder resin microparticles obtained in the core binder resin microparticle polymerization step (2-1).

In the aggregation and fusion step, wax microparticles and internal additive microparticles such as a charge control agent can be aggregated and fused together with the core binder resin microparticles and the coloring agent microparticles.

The “salting-out/fusion” means that aggregation and fusion are advanced in parallel, and when the particles grow to a desired particle diameter, an aggregation terminator is added to stop the particle growth, and further, if necessary, heating for controlling the particle shape is continuously performed.

The salting-out/fusion method is carried out as follows.

A salting-out agent made of an alkali metal salt, an alkaline earth metal salt, a trivalent salt and/or the like is added to an aqueous medium in which the core binder resin microparticles and the coloring agent microparticles are present, as a coagulant of a critical coagulation concentration or more. Next, the mixture is heated to a temperature which is equal to or higher than the glass transition point of the core binder resin microparticles and which is equal to or higher than the melting peak temperature of the core binder resin microparticles and the coloring agent microparticles, so that salting-out is allowed to proceed and, at the same time, aggregation and fusion are performed.

Examples of the alkali metal salt and the alkaline earth metal salt which are salting-out agents include lithium, potassium, sodium and the like as an alkali metal. Examples of the alkaline earth metal include magnesium, calcium, strontium, and barium, and preferable examples thereof include potassium, sodium, magnesium, calcium, and barium.

When the aggregation and fusion step is carried out by salting-out/fusion, it is preferable to shorten the standing time as much as possible after adding the salting-out agent.

The reason for this is not clear, but depending on the standing time after the salting-out, the aggregation state of the particles varies, and problems occur, for example, the particle size distribution becoming unstable, and the surface properties of the fused toner varies.

In addition, the temperature at which the salting-out agent is added needs to be at least equal to or lower than the glass transition point of the core binder resin microparticles.

The reason for this is that when the temperature at which the salting-out agent is added is equal to or higher than the glass transition point of the core binder resin microparticles, the salting-out/fusion of the core binder resin microparticles rapidly proceeds, but the particle diameter cannot be controlled, and a problem arises in that particles having a large particle diameter are generated.

This addition temperature is equal to or lower the glass transition point of the binder resin, but is generally in the range of 5 to 55° C., and preferably in the range of 10 to 45° C.

The salting-out agent is added at a temperature not higher than the glass transition point of the core binder resin microparticles, and then, by heating, the temperature is increased as quickly as possible to a temperature not lower than the glass transition point of the core binder resin microparticles and not lower than the melting peak temperature (° C.) of the core binder resin microparticles and the coloring agent microparticles.

The time for the increase in this temperature is preferably less than 1 hour. Furthermore, it is necessary to rapidly increase the temperature, and the temperature increase rate is preferably 0.25° C./min or more.

The upper limit is not particularly clear, but there is a problem that it is difficult to control the particle diameter because salting-out proceeds rapidly if the temperature is raised instantaneously, and thus the upper limit is preferably 5° C./min or less.

Through the above-described salting-out/fusion method, a dispersion of associated particles (core particles) formed by salting-out/fusion of the core binder resin microparticles and other microparticles is obtained.

The term “aqueous medium” refers to a medium made of 50 to 100 mass % of water and 0 to 50 mass % of a water-soluble organic solvent.

Examples of the water-soluble organic solvent include methanol, ethanol, isopropanol, butanol, acetone, methyl ethyl ketone, and tetrahydrofuran. Among these, alcohol-based organic solvents that do not dissolve the resin to be produced are preferable.

### (4) First Aging Step

In this step, the associated particles are aged by thermal energy. By controlling the heating temperature in the aggregation and fusion step (3) and particularly the heating temperature and time in the first aging step (4), the surface of the core particles formed to have a uniform particle diameter and a narrow distribution can be controlled to be smooth but to have a uniform shape.

Specifically, in the aggregation and fusion step (3), the heating temperature is set to be low to suppress the progress of fusion between the core binder resin microparticles and promote uniformity, and in the first aging step, the heating temperature is set to be low and the time is set to be long to control the surface of the core particles to have a uniform shape.

### (5) Shell Layer Forming Step

In this step, a shell formation treatment is performed in which the dispersion of the shell binder resin microparticles is added to the dispersion of the core particles to aggregate and fuse the shell binder resin microparticles on the surface of the core particles, thereby coating the surface of the core particles with the shell binder resin microparticles to form particles having a core-shell structure.

This step is a preferred production condition for imparting both the low-temperature fixability and the heat-resistant storage stability.

When a color image is formed, the shell layer is preferably formed in order to obtain high color reproducibility with respect to secondary colors.

Specifically, the dispersion of the shell binder resin microparticles is added to the dispersion of the core particles in the state in which the heating temperature in the aggregation and fusion step (3) and the first aging step (4) is maintained. The surface of the core particle is slowly covered with the shell binder resin microparticle taking several hours by continuous heating and stirring to form particles having a core-shell structure. The heating and stirring time is preferably within a range of 1 to 7 hours, and especially preferably within a range of 3 to 5 hours.

### (6) Second Aging Step

In this step, a terminator such as sodium chloride is added to stop particle growth at the stage at which the particles having a core-shell structure have reached a predetermined particle diameter through the shell layer formation step (5), and thereafter heating and stirring are continued for several hours in order to fuse the shell binder resin microparticles adhered to the core particles.

The thicknesses of the layer of the shell binder microparticles coating the surface of the core particles is in a range of 100 to 300 nm.

In this way, the shell binder resin microparticles are fixed to the surface of the core particles to form a shell layer, thereby forming rounded and uniformly shaped toner particles having a core-shell structure.

### (7) Filtration and Washing Step

In this step, first, a treatment of cooling the dispersion of the toner particles is performed. As a cooling treatment condition, it is preferable to perform cooling at a cooling rate of 1 to 20° C./min.

The cooling treatment method is not particularly limited, and examples thereof include a method of cooling by introducing a refrigerant from the outside of a reaction vessel, and a method of cooling by directly putting cold water into a reaction system.

Next, solid-liquid separation is performed to extract the toner particles from the dispersion of the toner particles cooled to a predetermined temperature, and then a washing treatment is performed in which deposits such as the surfactant and the salting-out agent are removed from a toner cake (an aggregate in which the toner particles in a wet state are aggregated in the form of a cake) obtained by the solid-liquid separation.

The filtration treatment method is not particularly limited, and examples thereof include a centrifugal separation method, a reduced pressure filtration method performed using a nutsche or the like, and a filtration method performed using a filter press or the like.

### (8) Drying Step

In this step, the washed toner cake is dried. Examples of the dryer used in this step can include a spray dryer, a vacuum freeze dryer, a reduced pressure dryer and the like, and it is preferable to use a stationary shelf dryer, a movable shelf dryer, a fluidized bed dryer, a rotary dryer, a stirring dryer or the like.

The moisture content of the dried toner particles is preferably 5% by mass or less, and more preferably 2% by mass or less.

Note that in a case where the dried toner particles are aggregated by a weak interparticle attractive force, the aggregate may be subjected to a pulverization treatment.

As a pulverization treatment apparatus, a mechanical crushing apparatus such as a jet mill, a Henschel mixer, a coffee mill, or a food processor can be used.

### (9) External Additive Treatment Step

In this step, a treatment of adding an external additive to the toner particles dried in the drying step (8) is performed.

As a method of adding the external additive, it can be performed using, for example, a mechanical mixer such as a Henschel mixer or a coffee mill.

(5.2) Step of Forming Image on Recording Medium using Electrostatic Charge Image Developing Toner

The electrostatic charge image developing toner used in this step is not particularly limited as long as it contains toner base particles containing a release agent. However, in the finally formed fixed image, it is necessary that the polar component γ^{p} of the surface energy of the image be equal to or greater than 5 mN/m², and the dispersion component γ^{d} of the surface energy of the image be equal to or greater than 20 mN/m².

The triaxial belt system imposes less pressure influence on the surface of the fixed image from the fixing belt during the formation of the fixed image than the biaxial belt system.

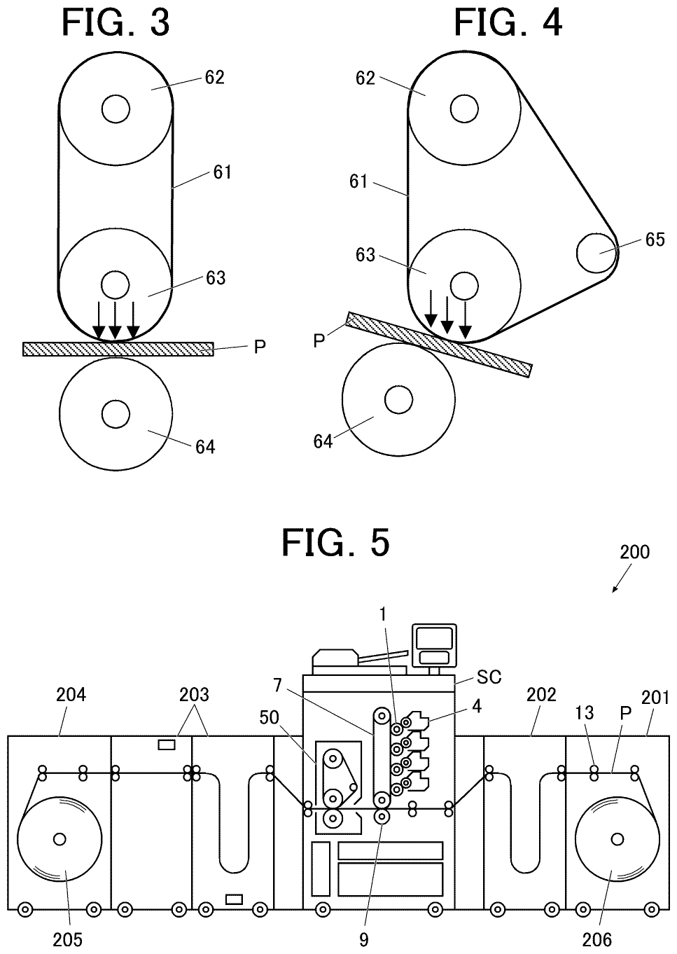

FIG. 3 is an example of a schematic sectional view of peripheral members around a fixed image forming point in a biaxial belt system of an image forming apparatus.

FIG. 4 is an example of a schematic sectional view of peripheral members around a fixed image forming point in a triaxial belt system of an image forming apparatus.

In FIG. 3 and FIG. 4, “61” represents a fixing belt, “62” represents a heating roller, “63” represents a fixing roller, “64” represents a pressure roller, “65” represents a tension roller, and “P” represents a recording medium, and arrows in FIG. 3 and FIG. 4 represent a pressure direction of pressure from the fixing roller to the recording medium.

In FIG. 3, the heating roller 62 functions as a “heater” of the present invention, and the fixing belt 61 is stretched over the heating roller 62 and the fixing roller 63.

In FIG. 4, the heating roller 62 functions as a “heater” of the present invention, and the fixing belt 61 is stretched over the heating roller 62, the fixing roller 63, and the tension roller 65.

As illustrated in FIG. 3, in the biaxial belt system, pressure is applied to a recording medium in a form in which the recording medium is firmly sandwiched between the upper and lower rollers. In contrast, as illustrated in FIG. 4, in the triaxial belt system, the upper and lower rollers sandwich a recording medium in a slightly shifted manner, thereby applying pressure thereto. Therefore, the pressure applied to the recording medium P is dispersed.

Since the pressure is thus dispersed, for example, the amorphous polyester contained in the fixed image is less likely to be buried in the toner, and the areas of the amorphous polyester and the styrene-acrylic resin exposed on the surface portion of the fixed image are increased. This improves the applicability of the liquid to the fixed image and the adhesiveness between the liquid and the fixed image.

Therefore, in the step of forming an image on a recording medium using the electrostatic charge image developing toner, it is preferable to use a fixing device of the triaxial belt system from the viewpoint that pressure applied to the recording medium during image formation is dispersed.

An example of the image forming apparatus employing the triaxial belt system is disclosed in FIG. 1 of Japanese Unexamined Patent Publication No. 2021-131517.

(5.3) Step of Winding Recording Medium with Fixed Image Formed

The step of forming an image on a recording medium using the electrostatic charge image developing toner and the step of winding the recording medium with the fixed image formed are linked with each other. When an image is formed on a recording medium, a tensile force applied to the recording medium by the recording medium being conveyed while being wound into a roll reduces minute wrinkles and the like of the recording medium as compared with the recording medium being simply carried. Thus, while an image is formed on a recording medium, the recording medium is wound into a roll, which can disperse the pressure applied to the recording medium.

Therefore, it is preferable that after the step of forming an image on a recording medium using the electrostatic charge image developing toner, the recording medium is wound into a roll, from the viewpoint that the pressure applied to the recording medium during image formation is dispersed.

From the foregoing, it is understood that as the image forming apparatus used in the image forming method of the present invention, a rotary press in which roll paper is set, and images are formed thereon is more suitable than a sheet-fed press using sheets cut one by one.

A rotary press has an excellent effect of dispersing the pressure applied to the recording medium during image formation as compared with a sheet-fed press, and therefore, for example, the amorphous polyester on the surface of the fixed image is less likely to be embedded in the toner, and the amount of the styrene-acrylic resin exposed on the surface of the fixed image increases. Therefore, the applicability of the liquid onto the fixed image is improved, and the adhesiveness of the liquid to the fixed image is also improved.

FIG. 5 illustrates an example of a configuration of an image forming apparatus provided with a system of winding a recording medium into a roll. In FIG. 5, “1” represents a photoreceptor, “4” represents a developing device, “7” represents an intermediate transfer belt, “9” represents a secondary transfer roller, “P” represents a recording medium, “SC” represents a document image reading device, “13” represents a conveyance roller, and “50” represents a fixing device. Furthermore, “200” represents an image forming apparatus, “201” represents an accommodation section, “202” and “203” represent conveyance units, “204” represents a storage section, “205” represents a winding roller, and “206” represents a feeding roller.

The image forming apparatus 200 includes the accommodation section 201 that accommodates a roll-shaped recording medium P, the conveyance unit 202 that conveys a continuous sheet of the recording medium P to an upstream portion of the sheet feeding and conveying apparatus, and the conveyance unit 203 that conveys the recording medium P on which a fixed image has been formed to a subsequent portion. The image forming apparatus 100 further includes the storage section 204 for storing the recording medium P conveyed from the conveyance unit 203 into a roll shape.

An example of the image forming apparatus provided with the system of winding a recording medium into a roll is illustrated in FIG. 2 of Japanese Unexamined Patent Publication No. 2019-203964.

### EXAMPLES

Hereinafter, the present invention will be specifically described with reference to Examples, but the present invention is not limited thereto. In Examples, “parts” and “%” mean “parts by mass” and “% by mass”, respectively, unless otherwise specified.

### Preparation of Dispersion

Amorphous vinyl resin microparticle dispersions [SA1] to [SA6], a crystalline polyester microparticle dispersion [CP1], amorphous polyester microparticle dispersions [AP1] to [AP7], and a coloring agent microparticle dispersion [1] were prepared as dispersions for producing toners.

### A. Preparation of Amorphous Vinyl Resin Microparticle Dispersions [SA1] to [SA5]

### (A.1) Preparation of Amorphous Vinyl Resin Microparticle Dispersion [SA1]

### (A.1.1) First Stage Polymerization

Into a 5 L reaction vessel provided with a stirrer, a temperature sensor, a cooling tube and a nitrogen introducing device, 8 parts by mass of sodium dodecyl sulfate and 3000 parts by mass of ion exchanged water were charged. The internal temperature of the reaction vessel was raised to 80° C., while stirring was performed at a stirring rate of 230 rpm under a nitrogen stream. Thus, a mixed solution was obtained.

To the mixed liquid, an aqueous solution in which 10 parts by mass of potassium persulfate (KPS) was dissolved in 200 parts by mass of ion exchanged water was added, the temperature of the mixed liquid was again adjusted to 80° C., and a monomer mixed liquid 1 having the following composition was added dropwise thereto taking 1 hour.

### Monomer Mixed Liquid 1

Styrene (St): 470 parts by mass
N-butyl acrylate (BA): 245 parts by mass
Methacrylic acid (MAA): 67 parts by mass

Thereafter, the mixture was heated and stirred at 80° C., for 2 hours to perform polymerization. Thus, a resin microparticle dispersion [a1] was prepared.

### (A.1.2) Second Stage Polymerization

Into a 5 L reaction vessel provided with a stirrer, a temperature sensor, a cooling tube, and a nitrogen introducing device, a solution in which 7 parts by mass of sodium polyoxyethylene (2) dodecyl ether sulfate was dissolved into 3000 parts by mass of ion exchanged water was charged. After the solution was heated to 80° C., 289 parts by mass of the resin microparticle dispersion [a1] and a monomer mixed liquid 2 in which monomers and a release agent of the following composition were dissolved at 90° C., were added thereto.

### Monomer Mixed Liquid 2

Styrene (St): 240 parts by mass
2-ethylhexyl acrylate (2EHA): 94.7 parts by mass
Methacrylic acid (MAA): 36 parts by mass
N-octyl-3-mercaptopropionate (NOM): 5.14 parts by mass
Fischer-Tropsch wax (release agent): 7.50 parts by mass

The Fischer-Tropsch wax is a hydrocarbon-based wax having a melting point of 82° C.

Thereafter, mixing and dispersing were performed for 30 minutes using a mechanical disperser “CLEARMIX” (“CLEARMIX” is a registered trade mark of M Technique Co., Ltd) having a circulatory path produced by M Technique Co., Ltd., to prepare an emulsified particle dispersion [a2] containing emulsified particles (oil droplets). The particle diameter of the release agent contained in the emulsified particle dispersion [a2] was controlled, and the particle diameter of the release agent was 150 nm.

The particle diameter of the release agent was determined by measuring the volume-based median diameter of the release agent particles in the dispersion with a laser diffraction particle size distribution analyzer “LA-750” (manufactured by HORIBA, Ltd).

Subsequently, an initiator solution in which 5.1 parts by mass of potassium persulfate (KPS) was dissolved in 200 parts by mass of ion exchanged water was added to the emulsified particle dispersion [a2], and the mixture was heated and stirred at 84° C., for 1 hour to perform polymerization. Thus, a resin microparticle dispersion [a3] was prepared.

### (A.1.3) Third Stage Polymerization

To the resin microparticle dispersion [a3], 400 parts by mass of ion exchanged water was added, and after the mixture was sufficiently mixed, a solution in which 6.9 parts by mass of potassium persulfate (KPS) was dissolved in 400 parts by mass of ion exchanged water was added. Under a temperature condition of 82° C., a monomer mixed liquid 3 having the following composition was added dropwise taking 1 hour to obtain a dispersion [a4].

### Monomer Mixed Liquid 3

Styrene (St): 341 parts by mass
N-butyl acrylate (BA): 165.7 parts by mass
Methacrylic acid (MAA): 48.6 parts by mass
N-octyl-3-mercaptopropionate (NOM): 9.1 parts by mass

Thereafter, the dispersion [a4] was heated and stirred for 2 hours for polymerization, and then cooled to 28° C., to prepare an amorphous vinyl resin microparticle dispersion [SA1] containing a vinyl resin (styrene-acrylic resin).

### (A.2) Preparation of Amorphous Vinyl Resin Microparticle Dispersion [SA2]

An amorphous vinyl resin microparticle dispersion [SA2] was prepared in the same manner as the amorphous vinyl resin microparticle dispersion [SA1] except that in the second stage polymerization, the used release agent was behenate, which is an ester-based wax having a melting point of 73° C.

### (A.3) Preparation of Amorphous Vinyl Resin Microparticle Dispersion [SA3]

An amorphous vinyl resin microparticle dispersion [SA3] was prepared in the same manner as the amorphous vinyl resin microparticle dispersion [SA2] except that in the second stage polymerization, mixing and dispersing were performed for 10 minutes with “CLEARMIX”.

### (A.4) Preparation of Amorphous Vinyl Resin Microparticle Dispersion [SA4]

An amorphous vinyl resin microparticle dispersion [SA4] was prepared in the same manner as the amorphous vinyl resin microparticle dispersion [SA2] except that in the second stage polymerization, mixing and dispersing were performed for 20 minutes with “CLEARMIX”.

### (A.5) Preparation of Amorphous Vinyl Resin Microparticle Dispersion [SA5]

An amorphous vinyl resin microparticle dispersion [SA5] was prepared in the same manner as the amorphous vinyl resin microparticle dispersion [SA2] except that in the second stage polymerization, mixing and dispersing were performed for 18 minutes with “CLEARMIX”.

### (A.6) Preparation of Amorphous Vinyl Resin Microparticle Dispersion [SA6]

In preparation of an amorphous vinyl resin microparticle dispersion [SA6], in the second stage polymerization, two types of release agent were used, and the types and the amounts of the used release agents are as follows.
Release agent (behenic acid behenate): 3.75 parts by mass
Release agent (Fischer-Tropsch wax): 3.75 parts by mass

Other than the above, the amorphous vinyl resin microparticle dispersion [SA6] was prepared in the same manner as the amorphous vinyl resin microparticle dispersion [SA4].

Table of Prepared Amorphous Vinyl Resin Microparticle Dispersions

The prepared amorphous vinyl resin microparticle dispersions [SA1] to [SA6] are summarized in Table I.

TABLE I
AMORPHOUS VINYL RESIN MICROPARTICLE DISPERSION

| | RELEASE AGENT | | | | | MIXING AND |
|---|---|---|---|---|---|---|
| | | | MELTING | PARTICLE | | DISPERSING |
| | | | POINT | DIAMETER | AMOUNT | TIME |
| No. | TYPE OF WAX | PRODUCT NAME | [° C.] | [nm] | [parts by mass] | [min.] |
| SA1 | HYDROCARBON-BASED | FISCHER-TROPSCH | 82 | 150 | 7.50 | 30 |
| | | WAX | | | | |
| SA2 | ESTER-BASED | BEHENIC ACID | 73 | 150 | 7.50 | 30 |
| | | BEHENATE | | | | |
| SA3 | ESTER-BASED | BEHENIC ACID | 73 | 250 | 7.50 | 10 |
| | | BEHENATE | | | | |
| SA4 | ESTER-BASED | BEHENIC ACID | 73 | 190 | 7.50 | 20 |
| | | BEHENATE | | | | |
| SA5 | ESTER-BASED | BEHENIC ACID | 73 | 220 | 7.50 | 18 |
| | | BEHENATE | | | | |
| SA6 | ESTER-BASED | BEHENIC ACID | 73 | 220 | 3.75 | 20 |
| | | BEHENATE | | | | |
| | HYDROCARBON-BASED | FISCHER-TROPSCH | 82 | | 3.75 | |
| | | WAX | | | | |

### B. Preparation of Crystalline Polyester Microparticle Dispersion [CP1]

The following monomers were put into a four-necked flask equipped with a nitrogen introduction tube, a dehydration tube, a stirrer, and a thermocouple, and heated to 190° C., to be dissolved.

### Monomers

Tetradecanedioic acid: 450 parts by mass
1,6-hexanediol: 266 parts by mass

Then, 0.8 parts by mass of Ti(OBu)₄ was added as an esterification catalyst, and the mixture was heated to 240° C., and allowed to react under atmospheric pressure (101.3 kPa) for 5 hours and under reduced pressure (8 kPa) for 1 hour.

Next, the mixture was cooled to 200° C., and then allowed to react under reduced pressure (20 kPa) for 1 hour, to produce crystal polyester [cp1].

Next, 100 parts by mass of the crystalline polyester [1] was dissolved in 400 parts by mass of ethylacetate (manufactured by Kanto Chemical Co., Inc), and the resultant was mixed with 638 parts by mass of sodium laurylsulfate having a concentration of 0.26% by mass prepared in advance to prepare a mixed liquid [C1].

The mixed liquid [C1] was subjected to ultrasonic dispersion treatment with an ultrasonic homogenizer US-150T (manufactured by NISSEI Corporation) at V-LEVEL 300 μA for 30 minutes with stirring.

Thereafter, the mixture was heated to 40° C., and stirred under reduced pressure for 3 hours using a diaphragm pump V-700 (manufactured by Buchi Labortechnik GmbH) to completely remove ethylacetate. Thus, a crystalline polyester microparticle dispersion [CP1] was prepared.

### C. Preparation of Amorphous Polyester Microparticle Dispersions [AP1] to [AP7]

### (C.1) Preparation of Amorphous Polyester Microparticle Dispersion [AP1]

A mixed liquid of the following monomer of vinyl resin, monomer having a substituent reactive with both the amorphous polyester and the vinyl resin, and polymerization initiator was placed in a dropping funnel α.

### Monomers and Polymerization Initiator

Styrene: 80.0 parts by mass
N-butyl acrylate: 20.0 parts by mass
Acrylic acid: 10.0 parts by mass
Di-t-butyl peroxide (polymerization initiator): 16.0 parts by mass

The following monomers of the amorphous polyester were put in a four-necked flask β equipped with a nitrogen introduction tube, a dehydration tube, a stirrer, and a thermocouple, and heated to 170° C., to be dissolved.

### Monomers of Amorphous Polyester

Bisphenol A ethylene oxide 2 mol adduct: 50.2 parts by mass
Bisphenol A propylene oxide 2 mol adduct: 249.8 parts by mass
Terephthalic acid: 120.1 parts by mass
Dodecenyl succinic acid: 46.0 parts by mass

Under stirring, the mixed liquid in the dropping funnel was added dropwise to the four-necked flask taking 90 minutes, and after aging for 60 minutes, the unreacted monomer was removed under reduced pressure (8 kPa).

Then, 0.4 parts by mass of Ti(OBu)₄ was added as an esterification catalyst, and the mixture was heated to 235° C., and allowed to react under atmospheric pressure (101.3 kPa) for 5 hours and under reduced pressure (8 kPa) for 1 hour.

Next, the mixture was cooled to 200° C., allowed to react under reduced pressure (20 kPa), and then desolvated to prepare amorphous polyester [ap1].

100 parts by mass of the amorphous polyester [ap1] was dissolved in 400 parts by mass of ethylacetate (manufactured by Kanto Chemical Co., Inc), and the resultant was mixed with 638 parts by mass of sodium laurylsulfate having a concentration of 0.26% by mass prepared in advance. While the mixture was stirred, ultrasonic dispersion treatment was performed with an ultrasonic homogenizer US-150T (manufactured by NISSEI Corporation) at V-LEVEL 200 μA for 15 minutes.

Thereafter, the mixture was heated to 40° C., and stirred under reduced pressure for 3 hours using a diaphragm pump V-700 (manufactured by Buchi Labortechnik GmbH) to completely remove ethylacetate. Thus, an amorphous polyester microparticle dispersion (AP1) having a solid content of 13.5% by mass was prepared. The amorphous polyester microparticles in the amorphous polyester microparticle dispersion [AP1] had a volume-based median diameter of 195 nm.

### (C.2) Preparation of Amorphous Polyester Microparticle Dispersions [AP2] to [AP7]

Amorphous polyester microparticle dispersions [AP2] to [AP7] were prepared in the same manner as the amorphous polyester microparticle dispersion [AP1] except the following (1) to (3).

(1) The monomer of the vinyl resin, the monomer having a substituent reactive with both the amorphous polyester and the vinyl resin, and the polymerization initiator placed in the dropping funnel α were changed as shown in Table II. In Table II, the monomer of the vinyl resin, the monomer having a substituent that reacts with both the amorphous polyester and the vinyl resin, and the polymerization initiator, which were placed in the dropping funnel α, are denoted as a monomer mixed liquid α.

(2) The monomers of the amorphous polyester placed in the four-necked flask β were changed as shown in Table II.

(3) The treatment conditions of the ultrasonic homogenizer US-150T were changed as shown in Table III.

TABLE II

| AMORPHOUS POLYESTER MICROPARTICLE | | | | | | | | |
|---|---|---|---|---|---|---|---|---|
| DISPERSION No. | | AP1 | AP2 | AP3 | AP4 | AP5 | AP6 | AP7 |
| MONOMER | STYRENE | 80.0 | 76.0 | 78.0 | 76.0 | 75.0 | 76.0 | 78.0 |
| MIXED LIQUID α | N-BUTYL ACRYLATE | 20.0 | 18.5 | 19.0 | 19.0 | 16.0 | 19.0 | 17.0 |
| | ACRYLIC ACID | 10.0 | 10.0 | 10.0 | 10.0 | 10.0 | 10.0 | 10.0 |
| | DI-T-BUTYL PEROXIDE | 20.0 | 16.0 | 18.0 | 19.0 | 16.0 | 16.0 | 20.0 |
| | (POLYMERIZATION INITIATOR) | | | | | | | |
| MONOMERS OF | BISPHENOL A ETHYLENE OXIDE | 50.2 | 48.0 | 49.0 | 49.0 | 48.0 | 48.0 | 48.0 |
| AMORPHOUS | 2 MOL ADDUCT | | | | | | | |
| POLYESTER | BISPHENOL A PROPYLENE | 249.8 | 235.0 | 238.0 | 238.0 | 235.0 | 235.0 | 235.0 |
| | OXIDE 2 MOL ADDUCT | | | | | | | |
| | TEREPHTHALIC ACID | 120.1 | 115.0 | 118.0 | 118.0 | 115.0 | 115.0 | 115.0 |
| | DODECENYL SUCCINIC ACID | 46.0 | 42.0 | 44.0 | 44.0 | 42.0 | 42.0 | 42.0 |

UNIT OF NUMERICAL VALUES IN TABLE IS PARTS BY MASS.

TABLE III
AMORPHOUS POLYESTER MICROPARTICLE DISPERSION

| | | HOMOGENIZER | |
|---|---|---|---|
| | Apes | ULTRASONIC CONDITION | |
| | PARTICLE | | DISPERSING |
| | DIAMETER | V-LEVEL | TIME |
| No. | [nm] | [μA] | [min.] |
| AP1 | 210 | 15 | 195 |
| AP2 | 200 | 25 | 166 |
| AP3 | 300 | 15 | 186 |
| AP4 | 220 | 20 | 178 |
| AP5 | 300 | 30 | 150 |
| AP6 | 200 | 30 | 159 |
| AP7 | 270 | 20 | 170 |

“APES” IN TABLE REPRESENTS AMORPHOUS POLYESTER.

### D. Preparation of Coloring Agent Microparticle Dispersion [1]

5 While a solution in which 90 parts by mass of sodium dodecylsulfate was added to 1600 parts by mass of ion exchanged water was stirred, 420 parts by mass of copper phthalocyanine (C. I. Pigment Blue 15:3) was gradually added thereto, to prepare a dispersion [Cu1].

Next, the dispersion [Cu1] was subjected to dispersion treatment using a stirring apparatus “CLEARMIX” (manufactured by M Technique Co., Ltd) to prepare a coloring agent microparticle dispersion [1]. The volume-based median diameter of the coloring agent microparticles in the coloring agent microparticle dispersion [1] was 120 nm.

### Preparation of Toner and Developer

### [1]Preparation of Toner 1

### [1-1] Production of Toner Base Particles

Into a reaction vessel equipped with a stirrer, a thermometer, and a cooling tube, 180 parts (in terms of solid content) of the amorphous vinyl resin microparticle dispersion [SA1] and 2000 parts by mass of ion exchanged water were put to prepare a dispersion [sa1]. Next, a 5 mol/L aqueous sodium hydroxide solution was added at room temperature (25° C.) to adjust the pH level of the dispersion [sa1] in the reaction vessel to 10.

In addition, 40 parts by mass (in terms of solid content) of the coloring agent microparticle dispersion [1] was put, and an aqueous solution in which 30 parts by mass of magnesium chloride as an aggregating agent was dissolved in 60 parts by mass of ion exchanged water was added under stirring at 30° C., taking 10 minutes.

After standing for 3 minutes, the system was heated to 80° C., taking 60 minutes, and when the temperature reached 80° C., 50 parts by mass (in terms of solids content) of the crystalline polyester microparticle dispersion [CP1] was added taking 10 minutes, and the stirring speed was adjusted so that the rate of growth of the particle diameter was 0.01 μm/min. The particles were grown until the volume-based median diameter measured by Coulter Multisizer 3 (manufactured by Beckman Coulter, Inc) reached 4.0 μm.

Next, 68 parts by mass (in terms of solids content) of the amorphous polyester microparticle dispersion [AP1] was added taking 30 minute. When the supernatant of the reaction liquid became transparent, an aqueous solution in which 190 parts by mass of sodium chloride was dissolved in 760 parts by mass of ion exchanged water was added to stop the growth of the particle diameter.

Further, the mixture was stirred in a state of 80° C., the average circularity of the toner particles was measured using a measuring apparatus “FPIA 3000” (manufactured by Sysmex Corporation), fusion of the particles was allowed to proceed until the average circularity reached 0.970, and the mixture was cooled to 30° C.

Next, solid-liquid separation was performed, and an operation of re-dispersing the dehydrated toner cake in ion exchanged water and performing solid-liquid separation was repeated three times for washing, followed by drying at 40° C., for 24 hours, to produce toner base particles [1].

### [1-2] External Additive Treatment

To 100 parts by mass of the toner base particles [1], 0.6 parts by mass of hydrophobic silica having a number average primary particle diameter of 12 nm and a hydrophobicity of 68 and 1.0 parts by mass of hydrophobic titanium dioxide having a number average primary particle diameter of 20 nm and a hydrophobicity of 63 were added as external additives. The external additives are referred to as external additive(s) [1].

The external additive [1] was mixed with the toner base particles [1] using a “Henschel mixer” (manufactured by Mitsui Miike Machinery Co., Ltd) at a rotor peripheral speed of 35 m/sec at 32°C., for 20 minutes to perform an external additive treatment, and coarse particles were removed using a sieve with openings of 45 μm to produce a toner 1.

### [2] Preparation of Toners 2 to 12 and 14 to 16

Toners 2 to 12 and 14 to 16 were produced in the same manner as the toner 1 except that the amorphous vinyl resin microparticle dispersion, the crystalline polyester microparticle dispersion, and the amorphous polyester microparticle dispersion to be used were as shown in Table IV.

### [3] Preparation of Toner 13

Note that the structure of the toner 13 was checked by a transmission electron microscope (TEM), but a core-shell structure was not formed.

### [4] Particle Diameter Measurement of Resin Particles

The particle diameter of the crystalline polyester and the particle diameter of the amorphous polyester in Table IV were measured by a laser diffraction particle size distribution analyzer “LA-700” (manufactured by Horiba, Ltd) using their resin microparticle dispersions.

TABLE IV

| TONER | | | | | | | |
|---|---|---|---|---|---|---|---|
| | | | | | AMORPHOUS | | |
| | | | | | POLYESTER | | |
| | | CRYSTALLINE POLYESTER | | | MICROPARTICLE | | |
| | AMORPHOUS VINYL | MICROPARTICLE DISPERSION | | | DISPERSION | | |
| | RESIN | | Cpes | | | Apes | |
| | MICROPARTICLE | | PARTICLE | | | PARTICLE | |
| | DISPERSION | | DIAMETER | AMOUNT | | DIAMETER | PRODUCIBILITY * |
| No. | No. | No. | [nm] | [% by mass] | No. | [nm] | 1 |
| 1 | SA1 | CP1 | 200 | 6.0 | AP1 | 195 | YES |
| 2 | SA2 | CP1 | 200 | 6.0 | AP1 | 195 | YES |
| 3 | SA3 | CP1 | 200 | 6.0 | AP2 | 166 | YES |
| 4 | SA4 | CP1 | 200 | 6.0 | AP3 | 186 | YES |
| 5 | SA5 | CP1 | 200 | 6.0 | AP4 | 178 | YES |
| 6 | SA5 | CP1 | 200 | 0.5 | AP4 | 178 | YES |
| 7 | SA5 | CP1 | 200 | 3.0 | AP4 | 178 | YES |
| 8 | SA5 | CP1 | 200 | 2.0 | AP4 | 178 | YES |
| 9 | SA5 | CP1 | 200 | 2.0 | AP4 | 178 | YES |
| 10 | SA6 | CP1 | 200 | 2.0 | AP4 | 178 | YES |
| 11 | SAG | CP1 | 200 | 2.0 | AP4 | 178 | YES |
| 12 | SA6 | CP1 | 200 | 2.0 | AP4 | 178 | YES |
| 13 | SA3 | CP1 | 200 | 6.0 | AP5 | 150 | NO |
| 14 | SA2 | CP1 | 200 | 6.0 | AP6 | 159 | YES |
| 15 | SA5 | CP1 | 200 | 6.0 | AP6 | 159 | YES |
| 16 | SA2 | CP1 | 200 | 6.0 | AP7 | 170 | YES |

* 1: “YES” UNDER “PRODUCIBILITY” REPRESENTS THAT TONER WAS BEEN ABLE TO BE PRODUCED, WHEREAS “NO” UNDER “PRODUCIBILITY” REPRESENTS THAT TONER WAS NOT BEEN ABLE TO BE PRODUCED.
“APES” IN TABLE REPRESENTS AMORPHOUS POLYESTER.
“CPES” IN TABLE REPRESENTS CRYSTALLINE POLYESTER.

### [5] Preparation of Developer

Ferrite carriers having a volume average particle diameter of 30 μm and coated with a copolymer resin of cyclohexyimethacrylate and methylmethacrylate (monomer mass ratio=1:1) were used. Developers 1 to 16 were produced by mixing the ferrite carriers with the toners such that the toner concentration became 6% by mass.

Table V shows the composition of each developer.

TABLE V

| | | | | CRYSTALLINE | AMORPHOUS | | |
|---|---|---|---|---|---|---|---|
| | | AMORPHOUS VINYL RESIN | | POLYESTER | POLYESTER | | |
| | | MICROPARTICLE DISPERSION | | MICROPARTICLE | MICROPARTICLE | COLORING | EXTERNAL |
| DEVELOPER | TONER | | RELEASE AGENT | DISPERSION | DISPERSION | AGENT | ADDITIVE |
| No. | No. | No. | TYPE | No. | No | No. | No. |
| 1 | 1 | SA1 | HYDROCARBON-BASED | CP1 | AP1 | 1 | 1 |
| 2 | 2 | SA2 | ESTER-BASED | CP1 | AP1 | 1 | 1 |
| 3 | 3 | SA3 | ESTER-BASED | CP1 | AP2 | 1 | 1 |
| 4 | 4 | SA4 | ESTER-BASED | CP1 | AP3 | 1 | 1 |
| 5 | 5 | SA5 | ESTER-BASED | CP1 | AP4 | 1 | 1 |
| 6 | 6 | SA5 | ESTER-BASED | CP1 | AP4 | 1 | 1 |
| 7 | 7 | SA5 | ESTER-BASED | CP1 | AP4 | 1 | 1 |
| 8 | 8 | SA5 | ESTER-BASED | CP1 | AP4 | 1 | 1 |
| 9 | 9 | SA5 | ESTER-BASED | CP1 | AP4 | 1 | 1 |
| 10 | 10 | SA6 | ESTER-BASED | CP1 | AP4 | 1 | 1 |
| | | | HYDROCARBON-BASED | | | | |
| 11 | 11 | SA6 | ESTER-BASED | CP1 | AP4 | 1 | 1 |
| | | | HYDROCARBON-BASED | | | | |
| 12 | 12 | SA6 | ESTER-BASED | CP1 | AP4 | 1 | 1 |
| | | | HYDROCARBON-BASED | | | | |
| 13 | 13 | SA3 | ESTER-BASED | CP1 | AP5 | 1 | 1 |
| 14 | 14 | SA2 | ESTER-BASED | CP1 | AP6 | 1 | 1 |
| 15 | 15 | SA5 | ESTER-BASED | CP1 | AP6 | 1 | 1 |
| 16 | 16 | SA2 | ESTER-BASED | CP1 | AP7 | 1 | 1 |

### Image Formation Evaluation

### <1> Formation of Image

### <1-1> Formation of Image [1]

A commercially available full-color multifunction peripheral “AccurioPress C3080” manufactured by Konica Minolta, Inc. was used as an image forming apparatus. Hereinafter, this image forming apparatus is referred to as a sheet-fed press [1]. Note that the image forming method of the sheet feeder [1] adopts a biaxial belt system.

In the sheet-fed press [1], the developer [1] was placed, and a solid image having a toner adhesion amount of 8.0 g/m² was formed on A4 (basis weight: 157 g/m²) gloss coated paper under a normal-temperature and normal-humidity (temperature: 20° C., relative humidity: 50%) environment, and formed (fixed) at a fixing temperature of 180° C.

### <1-2> Formation of Images [2] to [10]

The sheet-fed press [1] described above was used as an image forming apparatus.

Images [2] to [10] were formed in the same manner as in the image [1] except that as shown in Table VI, the developers [2] to [10] were placed in the sheet-fed press [1].

### <1-3> Formation of Image

A commercially available color multifunction peripheral “bizhub PRESS C1100” manufactured by Konica Minolta, Inc. was used as an image forming apparatus. Hereinafter, this image forming apparatus is referred to as a sheet-fed press [2]. Note that the image forming method of the sheet feeder [2] adopts a triaxial belt system.

The developer [11] shown in Table VI was placed in the sheet-fed press [2] modified such that the temperature of the fixing roller was able to be set, and a solid image having a toner adhesion amount of 8.0 g/m² was formed on A4 (basis weight: 157 g/m²) gloss coated paper under a normal-temperature and normal-humidity (temperature: 20° C., relative humidity: 50%) environment, and formed (fixed) at a fixing temperature of 180° C.

### <1-4> Formation of Image

A commercially available color multifunction peripheral “bizhub PRESS C71cf” manufactured by Konica Minolta, Inc. was used as an image forming apparatus. Hereinafter, the image forming apparatus is referred to as a rotary press [1]. Note that the image forming method of the rotary press [1] adopts a triaxial belt system.

In the rotary press [1], the recording medium is fed out from a state of being wound in a roll shape, and the recording medium is conveyed in the image forming apparatus. Next, after the toner image is formed on the recording medium, the recording medium is rewound into a roll. Thus, the recording medium set in the rotary press [1] is wound in a roll shape and set, and after the toner image is printed on the recording medium, the recording medium is wound again into a roll shape and stored.

In the rotary press [1], the developer [12] shown in Table VI is placed, and a solid image having a toner adhesion amount of 8 g/m² was formed on a 96 μm-thick TAC PP under a normal-temperature and normal-humidity (temperature: 20° C., relative humidity: 50%) environment. Note that the apparatus was modified such that the fixing temperature, the amount of toner adhesion, and the system speed were able to be freely set, and image formation was performed at a fixing temperature of 185° C., and a system speed of 270 mm/sec.

### <1-5> Formation of Image [13]

Since the developer 13 was prepared using the toner 13 having no core-shell structure, image formation was not performed.

### <1-6> Formation of Images [14] to [16]

The sheet-fed press [1] described above was used as an image forming apparatus.

Images [14] to [16] were formed in the same manner as the image [1] except that as shown in Table VI, the developers [14] to [16] were placed in the sheet-fed press [1].

### <1-7> Measurement of Surface Energy

As liquids, water, diiodomethane, and n-hexadecane were applied to the produced images [1] to [12] and [14] to [16]. The contact angle of each fixed image with respect to each liquid is measured using a fully automatic contact angle meter “DMo-701” manufactured by Kyowa Interface Science Co., Ltd, and each component of the surface energy of each image is calculated using the theoretical formula of Kitazaki and Hata on the basis of the measurement result with respect to each liquid. The calculation results are shown in Table VI.

### <2> Evaluation of Fixing Separability

The fixing separability between the heating/fixing roller on the image side and the recording medium at the time of production of the images [1] to [12] and [14] to [16] was evaluated according to the following evaluation criteria. Those having an evaluation criterion of “A” or “B” was considered to have no practical problem and was considered to have passed. The evaluation results are shown in Table VI.

### Evaluation Criteria

A: A recording medium separates from the heating/fixing roller without being curled.
B: A recording medium separates from the heating/fixing roller with the leading end of the recording medium slightly curled.
C: A recording medium separates from the heating/fixing roller with unevenness in gloss of the image surface. or a recording medium is wound around the heating/fixing roller and cannot separate from the heating/fixing roller.

### <3> Evaluation of Varnish Applicability and Varnish Adhesiveness

### <3-1> Formation of Varnish Layer

On the produced images [1] to [12] and [14] to [16], “UV VECTA COAT VARNISH PC-3KW2” manufactured by T&K Co., Ltd. was applied with a bar coater so as to be 5 μm thick.

Thereafter, ultraviolet rays were emitted using a high-pressure mercury lamp such that the integrated light amount on each image surface was 120 to 130 mJ/cm², and the varnish was cured to form varnish layers on the images [1] to [12] and [14] to [16].

### <3-2> Evaluation of Varnish Applicability

The surfaces of the images [1] to [12] and [14] to [16] on which the varnish layers were formed were visually observed, and the varnish applicability was evaluated on the basis of the presence or absence of repelling according to the following evaluation criteria. Those having an evaluation criterion of “A”, “B”, or “C” were considered to have no practical problem and were considered to have passed. The evaluation results are shown in Table VI.

### Evaluation Criteria

A: There are no pinholes in the area of 10 cm×10 cm.
B: There are one to two minute pinholes in the area of 10 cm×10 cm.
C: There are three to ten minute pinholes in the area of 10 cm×10 cm.
D: There are 11 or more pinholes or repelling occurs in the area of 10 cm×10 cm.

### <3-3> Evaluation of Varnish Adhesiveness

For the images [1] to [12] and [14] to [16] on which the varnish layers were formed, the varnish fixing ratios were calculated using a mending tape peeling method of the following (1) to (6).
(1) Regarding an image, a photograph is taken at a magnification of 100 times using a digital microscope “VHX-6000” manufactured by Keyence Corporation, and binarization is performed with “LUSEX-AP” manufactured by Nireco Corporation.
(2) “Mending Tape” (No. 810-3-12) manufactured by Sumitomo 3M Co., Ltd. is lightly attached to the image.
(3) The tape is rubbed back and forth 3.5 times with a pressure of 1 kPa.
(4) The tape is peeled off at an angle of 180° with a force of 200 g.
(5) The image with the tape peeled off is photographed at a magnification of 100 times using a digital microscope “VHX-6000” manufactured by Keyence Corporation, and binarization is performed with “LUSEX-AP” manufactured by Nireco Corporation.
(6) The varnish fixing ratio is calculated by the following formula.

$$Varnish Fixing Ratio [ \% ] = ( 1 - Area of Concealing Portion with Varnish with respect to Image Region after Tape Peeling ) / Area of Concealing Portion with Powder with respect to Image Region made of Resin before Tape Peeling ) \times 100$$

The adhesiveness between the varnish layer and each image, that is, the varnish adhesiveness, was evaluated based on the following evaluation criteria. Those having an evaluation criterion of “A”, “B”, or “C” were considered to have no practical problem and were considered to have passed. The evaluation results are shown in Table VI.

### Evaluation Criteria

A: There is no vanish peeling.
B: The varnish fixing ratio [%] is less than 3%.
C: The varnish fixing ratio [%] is 3% or more and less than 5%.
D: The varnish fixing ratio [%] is 5% or more and less than 10%.
E: The varnish fixing ratio [%] is 10% or more.

### <4> Laminate Adhesiveness

### <4-1> Formation of Protective Layer

The 35-μm-thick over-laminate film “3210G” manufactured by ARLON Corporation was laminated over the entire surface of each image using a laminator “RS685HC” manufactured by Nippon Office Laminator K. K. at a speed set to 6 m/min. to cover the image and form a protective layer on the image.

### <4-2> Evaluation of Laminate Adhesiveness

The adhesiveness between each image on which the protective layer was formed by a laminate and the laminate, that is, the laminate adhesiveness, was evaluated by calculating the area ratio of the image peeled off by the laminate using a cross-cut tape peeling method, according to the following evaluation criteria. Those having an evaluation criterion of “A”, “B”, or “C” were considered to have no practical problem and were considered to have passed. The evaluation results are shown in Table VI.

### Evaluation Criteria

A: There is no peeling due to a laminate (i.e., by lamination).
B: The area of a toner image peeled off due to a laminate is less than 3% with respect to the area of a solid image.
C: The area of a toner image peeled off due to a laminate is 3% or more and less than 5% with respect to the area of a solid image.
D: The area of a toner image peeled off due to a laminate is 5% or more and less than 10% with respect to the area of a solid image.
E: The area of a toner image peeled off due to a laminate is 10% or more with respect to the area of a solid image.

TABLE VI

| | | | | | OUTPUT MACHINE | | | | | | |
|---|---|---|---|---|---|---|---|---|---|---|---|
| EXAMPLE OR | | | IMAGE | | | NUMBER | | EVALUATION | | | |
| COMPARATIVE | DEVELOPER | IMAGE | γ^{p} | γ^{d} | | OF AXES | WINDING | | *2 | ADHESIVENESS | |
| EXAMPLE | No. | No. | [mN/m²] | | TYPE | OF BELT | INTO ROLL | *1 | *3 | *3 | LAMINATE |
| EXAMPLE 1 | 1 | 1 | 32.3 | 34.0 | SHEET-FED | 2 | ABSENT | B | C | A | C |
| | | | | | PRESS 1 | | | | | | |
| EXAMPLE 2 | 2 | 2 | 31.7 | 33.6 | SHEET-FED | 2 | ABSENT | A | C | A | C |
| | | | | | PRESS 1 | | | | | | |
| EXAMPLE 3 | 3 | 3 | 5.4 | 19.3 | SHEET-FED | 2 | ABSENT | A | B | A | C |
| | | | | | PRESS 1 | | | | | | |
| EXAMPLE 4 | 4 | 4 | 28.7 | 27.9 | SHEET-FED | 2 | ABSENT | A | A | B | C |
| | | | | | PRESS 1 | | | | | | |
| EXAMPLE 5 | 5 | 5 | 17.4 | 24.3 | SHEET-FED | 2 | ABSENT | A | A | B | C |
| | | | | | PRESS 1 | | | | | | |
| EXAMPLE 6 | 6 | 6 | 18.2 | 25.2 | SHEET-FED | 2 | ABSENT | A | A | A | C |
| | | | | | PRESS 1 | | | | | | |
| EXAMPLE 7 | 7 | 7 | 17.6 | 25.0 | SHEET-FED | 2 | ABSENT | A | A | A | C |
| | | | | | PRESS 1 | | | | | | |
| EXAMPLE 8 | 8 | 8 | 18.3 | 25.4 | SHEET-FED | 2 | ABSENT | A | A | A | B |
| | | | | | PRESS 1 | | | | | | |
| EXAMPLE 9 | 9 | 9 | 18.0 | 25.6 | SHEET-FED | 2 | ABSENT | A | A | A | B |
| | | | | | PRESS 1 | | | | | | |
| EXAMPLE 10 | 10 | 10 | 17.5 | 24.9 | SHEET-FED | 2 | ABSENT | B | A | A | B |
| | | | | | PRESS 1 | | | | | | |
| EXAMPLE 11 | 11 | 11 | 17.7 | 24.8 | SHEET-FED | 3 | ABSENT | B | A | A | A |
| | | | | | PRESS 2 | | | | | | |
| EXAMPLE 12 | 12 | 12 | 18.1 | 25.0 | ROTARY | 3 | PRESENT | B | A | A | A |
| | | | | | PRESS 1 | | | | | | |
| COMPARATIVE | 13 | 13 | — | — | — | — | — | — | — | — | — |
| EXAMPLE 1 | | | | | | | | | | | |
| COMPARATIVE | 14 | 14 | 2.3 | 18.7 | SHEET-FED | 2 | ABSENT | C | D | E | E |
| EXAMPLE 2 | | | | | PRESS 1 | | | | | | |
| COMPARATIVE | 15 | 15 | 2.6 | 21.1 | SHEET-FED | 2 | ABSENT | C | C | E | D |
| EXAMPLE 3 | | | | | PRESS 1 | | | | | | |
| COMPARATIVE | 16 | 16 | 7.4 | 17.2 | SHEET-FED | 2 | ABSENT | C | C | D | E |
| EXAMPLE 4 | | | | | PRESS 1 | | | | | | |

*1: FIXING SEPARABILITY
*2: APPLICABILITY
*3: VARNISH

### <5> Overall Remarks

As it is obvious from Table VI, it is understood that Examples are excellent in fixing separability, varnish applicability, varnish adhesiveness, and laminate adhesiveness as compared with Comparative Examples.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. An image forming method comprising forming an image on a recording medium with an electrostatic charge image developing toner,
wherein the electrostatic charge image developing toner includes a toner base particle containing a release agent,
wherein a polar component γ^{p} of a surface energy of the image is equal to or more than 5 mN/m², and
wherein a dispersion component γ^{d} of the surface energy of the image is equal to or more than 20 mN/m².

2. The image forming method according to claim 1,
wherein the polar component γ^{p} of the surface energy of the image is equal to or less than 30 mN/m², and
wherein the dispersion component γ^{d} of the surface energy of the image is equal to or less than 30 mN/m².

3. The image forming method according to claim 1,
wherein the toner base particle contains a crystalline polyester, and
wherein a content of the crystalline polyester is in a range of 0.5 to 3.0% by mass.

4. The image forming method according to claim 1, wherein the toner base particle contains at least an ester-based wax as the release agent.

5. The image forming method according to claim 1, wherein a fixing device of a triaxial belt system is used in forming the image on the recording medium with the electrostatic charge image developing toner.

6. The image forming method according to claim 1, further comprising winding the recording medium into a roll after forming the image on the recording medium with the electrostatic charge image developing toner.
